(19) United States
(12) Patent Application Publication
(10) Pub. No.: US 2026/0238702 A1
(43) Pub. Date: Aug. 13, 2026

(54) UTILIZING DIGITAL PAGE SEQUENCE TOKENS WITH LARGE LANGUAGE MODELS TO GENERATE DIGITAL USER ACTIVITY PREDICTIONS

(71) Applicant: Adobe Inc., San Jose, CA (US)

(72) Inventors: Harshita Chopra, New Delhi (IN); Atanu R Sinha, Bangalore (IN); Sai Narayan Sundaresan, Chennai (IN); Raghav Karan, New Delhi (IN); Nagasai Saketh Naidu, Hyderabad (IN); N Anushka, Bhubaneswar (IN); Koustava Goswami, Bangalore (IN)

(21) Appl. No.: 19/050,836

(22) Filed: Feb. 11, 2025

(51) Int. Cl. H04L 67/50; G06F 40/284; H04L 67/146

(52) U.S. Cl. CPC H04L 67/535; G06F 40/284; H04L 67/146

(57) ABSTRACT

This disclosure describes one or more implementations of systems, non-transitory computer-readable media, and methods that utilize a large language model as a base model to generate and utilize digital page navigation predictions with a variety of downstream user activity prediction tasks. Indeed, in one or more instances, the disclosed systems utilize the digital page navigation predictions from the large language model to derive multiple downstream predictive user activity tasks. In particular, in one or more implementations, the disclosed systems utilize the digital page navigation predictions with a variety of downstream user activity prediction models to generate user activity predictions for a user associated with the digital page navigation predictions. Moreover, in one or more implementations, the disclosed systems train a large language model to predict page sequences using a page order agnostic and contrastive measure of loss from training input-output page sequence pairs.

### BACKGROUND

In recent years, computing systems have increasingly used intelligent models to select and transmit digital content to client devices by generating client device predictions. For instance, some existing intelligent analytics tools monitor client devices interactions and generate various predictions utilizing computer-based models. Although such conventional systems analyze and predict client behavior utilizing computer-based models, they have a number of technical shortcomings. For instance, such conventional systems often suffer from problems related to inaccuracy due to limited contextual information in addition to rigidity and computational inefficiencies for implementing devices.

To illustrate, conventional systems oftentimes operate without sufficient context, which results in incomplete and inefficient predictions. For example, in many cases, conventional systems utilize models to predict various client behaviors but generate these predictions with limited underlying contextual data. As a result, conventional systems often generate predictions that are unactionable. Moreover, many conventional systems also require client-level characteristics and information to generate accurate behavior predictions. Processing of such high-volume, client-level characteristics often requires a substantial amount of computational processing and inefficient utilization of computer resources.

Moreover, although conventional systems often utilize machine learning models to predict client behavior, many of these conventional systems use machine learning with limited contextual information. In many cases, conventional systems utilize document repositories and/or analytical data to generate client predictions-which oftentimes, as mentioned above, fails to generate predictions based on individual client contextual information. Moreover, many conventional systems generate recommendations and/or search results utilizing reactive behaviors that is retroactive and fails to capture proactive client conduct.

Furthermore, many conventional systems are limited to training on predefined length and order specific predictions. In many cases, such rigid training of models limits the accuracy and flexibility of models to generate generalized and accessible predicted data. In addition, many conventional systems are limited in the quantity of training data due to the predefined length and order specific prediction training of conventional models. Indeed, conventional systems oftentimes are limited to models that generate predefined predictions from predefined inputs lengths. For instance, many conventional systems utilize machine learning (e.g., long short-term memory models) with a predetermined input length and format of input data (e.g., user data, specifically formatted tabular data) to generate client predictions. Furthermore, such conventional systems are limited to a predefined length of output (e.g., a binary classification, retrieval). Furthermore, conventional systems often utilize machine learning models to generate specific client predictions that are not scalable to a wide variety of systems or use cases without significant modification and/or retraining (or retuning).

Additionally, conventional systems that utilize machine learning to predict user behavior data are often inefficient. For instance, many conventional systems utilize extensive training to tune machine learning models to generate client predictions from client data. As mentioned above, many of these conventional systems are focused on predetermined inputs and output formats such that individual downstream tasks require retraining a model for the particular downstream task. Accordingly, many conventional systems inefficiently utilize multiple machine learning models and training of the multiple machine learning models to implement (or execute) different downstream tasks. In addition, many conventional systems require a large set of training data to generate accurate predictions. Moreover, to scale many conventional machine learning prediction models, the models require extensive training data.

### SUMMARY

This disclosure describes one or more embodiments of systems, computer-readable media, and computer-implemented methods that solve the foregoing problems and provide other benefits. In one or more instances, the disclosed systems utilize tokenized page sequence data from navigation sessions with large language models to generate digital page navigation predictions for client devices. In addition, in one or more embodiments, the disclosed systems utilize the large language model as a base model to generate and utilize digital page navigation predictions with a variety of downstream user activity prediction tasks. Indeed, in one or more instances, the disclosed systems utilize the digital page navigation predictions from the large language model to derive multiple downstream predictive user activity tasks. In particular, in one or more implementations, the disclosed systems utilize the digital page navigation predictions with a variety of downstream user activity prediction models to generate user activity predictions for a user associated with the digital page navigation predictions. Furthermore, by utilizing a large language model with tokenized page sequence data from page name data, the disclosed systems, in some instances, enable a variety of task-specific downstream tasks from input page name data. Moreover, in one or more implementations, the disclosed systems train a large language model to predict page sequences using a page order agnostic and contrastive measure of loss from training input-output page sequence pairs.

### BRIEF DESCRIPTION OF THE DRAWINGS

The detailed description is described with reference to the accompanying drawings in which:

FIG. 1 illustrates a schematic diagram of an example environment in which a digital page sequence machine learning system operates in accordance with one or more implementations.

FIG. 2 illustrates an overview of a digital page sequence machine learning system utilizing predicted page sequences to generate user activity predictions for a user in accordance with one or more implementations.

FIG. 3 illustrates a digital page sequence machine learning system generating user navigation session tokens from digital user navigation data utilizing structured page descriptors in accordance with one or more implementations.

FIG. 4 illustrates a digital page sequence machine learning system utilizing a predicted page sequence with a user activity prediction model to generate a predicted user activity in accordance with one or more implementations.

FIG. 5 illustrates a digital page sequence machine learning system utilizing predicted user activity to select (or generate) digital content for one or more client devices in accordance with one or more implementations.

FIG. 6 illustrates a digital page sequence machine learning system training a large language model to generate predicted page sequences utilizing a contrastive, page order agnostic loss in accordance with one or more implementations.

FIG. 7 illustrates an example output predicted page sequence generated by a large language model in accordance with one or more implementations.

FIGS. 8A-8C illustrate a digital page sequence machine learning system displaying generated user activity predictions from page sequence data in accordance with one or more implementations.

FIG. 9 illustrates a digital page sequence machine learning system utilizing the predicted page sequence to generate user segments in accordance with one or more implementations.

FIG. 10 illustrates a schematic diagram of a digital page sequence machine learning system in accordance with one or more implementations.

FIG. 11 illustrates a flowchart of a series of acts for utilizing predicted page sequence data from large language models to generate user activity predictions for users in accordance with one or more implementations.

FIG. 12 illustrates a flowchart of a series of acts for training a large language model to generate predicted page sequence data in accordance with one or more implementations.

FIG. 13 illustrates a block diagram of an example computing device in accordance with one or more implementations.

### DETAILED DESCRIPTION

This disclosure describes one or more implementations of a digital page sequence machine learning system that utilizes digital page sequence data with a large language model to generate digital page navigation predictions for downstream user activity prediction tasks. In particular, the digital page sequence machine learning system combines predicted future user navigation sessions generated from a large language machine learning model using webpage sequence tokens with the utilization of downstream user activity prediction models to generate additional user behavior predictions. For example, by utilizing the predicted future user navigation sessions with the additional downstream models, the digital page sequence machine learning system generates predicted user activities, such as specific target predictions, time instances of future visits, user consumption frequencies, target conversion outcomes for users, user segmentations, and/or product recommendations. In addition, in one or more implementations, the digital page sequence machine learning system trains a large language model to predict user navigation session sequences of users utilizing a contrastive page order agnostic measure of loss.

Indeed, as mentioned above, conventional systems often suffer from problems related to accuracy, rigidity, and efficiency stemming from operating without sufficient context (resulting in incomplete and inefficient predictions), training on predefined length and order specific predictions, and/or utilizing extensive training to tune machine learning models to generate client predictions from client data. Unlike such conventional systems, the digital page sequence machine learning system improves the accuracy of digital page navigation predictions by combining predicted future user navigation sessions generated from a large language machine learning model with the utilization of downstream user activity prediction models to generate accurate and granular user behavior predictions. Moreover, the digital page sequence machine learning system also generates the output predicted page sequence without a predetermined size of sequence or order and enables the output predicted page sequence to be utilized by a variety of downstream tasks. Additionally, in contrast to many conventional systems that utilize different components or machine learning models to train (or generate) different inferences for downstream tasks, in one or more implementations, the digital page sequence machine learning system efficiently utilizes the output predicted page sequence data from the singular large language model to execute a variety of downstream tasks. Indeed, several advantages of the digital page sequence machine learning system over conventional systems are described in greater detail below.

To illustrate, the digital page sequence machine learning system generates user navigation session tokens from page sequence descriptors (e.g., page names) from a user navigation session of a user. Moreover, in one or more implementations, the digital page sequence machine learning system utilizes a large language model with the user navigation session tokens to generate a predicted page sequence for a future (additional) user navigation session of the user. In addition, in one or more instances, the digital page sequence machine learning system utilizes the predicted page sequence with downstream user activity prediction models to generate predicted user activities (or behaviors) of the user. For example, the digital page sequence machine learning system determines a predicted user activity of the user (from the predicted page sequence) and selects digital content for a client device of the user based on the predicted user activity of the user.

Furthermore, in one or more instances, the digital page sequence machine learning system also trains a large language model to predict user navigation session sequences of users utilizing a contrastive page order agnostic measure of loss. For example, the digital page sequence machine learning system utilizes a large language model with input training session tokens to generate predicted output tokens. Moreover, in one or more instances, the digital page sequence machine learning system determines a contrastive measure of loss using maximum and minimum measures of loss between the predicted output tokens and ground truth training output tokens. Indeed, in one or more implementations, the digital page sequence machine learning system utilizes a rolling window of losses between predicted output tokens and ground truth training output tokens to generate a contrastive loss that is page order agnostic. Indeed, in one or more implementations, the digital page sequence machine learning system modifies parameters of the large language model using the contrastive loss.

In one or more instances, the digital page sequence machine learning system utilizes digital page sequence data with large language models to generate digital page navigation predictions for client devices. In particular, in one or more implementations, the digital page sequence machine learning system leverages large language models with customized page sequence input prompts to predict page sequences in additional digital navigation sessions. Furthermore, in one or more implementations, the digital page sequence machine learning system utilizes large language models to generate predicted page sequences with variable lengths. For instance, the digital page sequence machine learning system tokenizes page sequences from digital user navigation data and utilize the tokenized page sequences to create input prompts (e.g., zero-shot and/or few-shot input prompts) to utilize with a large language model to generate page sequence predictions.

Furthermore, in one or more instances, the digital page sequence machine learning system utilizes a data schema structure having category, subcategory, and/or product data (as part of the page descriptor data from the user navigation data) with the large language model to increase the accuracy of predicted page sequences. In particular, in one or more implementations, the digital page sequence machine learning system tokenizes category, subcategory, and/or product data corresponding to the page descriptor data. Indeed, in one or more instances, the digital page sequence machine learning system utilizes the tokenized category, subcategory, and/or product data (related to the data schema structure) with the large language model to generate predicted page sequences that accurately determine target categories and/or products associated with user activity (e.g., predict user navigation to a particular product or category page). In one or more implementations, the digital page sequence machine learning system also trains the large language model utilizing a dataset of training input session tokens and output session tokens (as described herein) that includes category, subcategory, and/or product data. In some cases, the data schema structure further includes brand information for the product data (e.g., indicating a particular brand or manufacturer of a product).

Moreover, as mentioned above, in one or more implementations, the digital page sequence machine learning system utilizes predicted page sequences of users to generate predicted user activities. In some instances, the digital page sequence machine learning system utilizes the predicted page sequences with downstream user activity prediction models to generate the predicted user activities. For instance, the digital page sequence machine learning system generates (or determines) specific user activities from a combination of predicted page sequences and user activity insights from the downstream user activity prediction models. In some cases, the digital page sequence machine learning system generates (or determines) specific user activities by utilizing the predicted page sequences (e.g., as context or input) for the downstream user activity prediction models.

For example, the digital page sequence machine learning system utilizes the predicted page sequence generated from the large language model (with a user activity prediction model) to generate predicted category targets, predicted product page targets, and/or user journey targets. Moreover, in some implementations, the digital page sequence machine learning system utilizes the predicted page sequence (with a user activity prediction model) to generate predicted target conversion outcomes for a user. Additionally, in one or more instances, the digital page sequence machine learning system utilizes the predicted page sequence (with a user activity prediction model) to generate predicted time-instance for a particular (future) page visit of a user, a user consumption frequency prediction, and/or a content (or product) recommendation for the user. Additionally, in one or more implementations, the digital page sequence machine learning system utilizes predicted page sequences (or resulting predicted user activities) with an inventory forecasting model to generate predicted inventories of websites.

Furthermore, as mentioned above, in one or more instances, the digital page sequence machine learning system utilizes a predicted page sequence and/or a predicted user activity derived from the predicted page sequence to select digital content for a client device of a user corresponding to the user navigation data. In one or more instances, the digital page sequence machine learning system utilizes the predicted page sequences and/or the predicted user activities to, but not limited to, generate (or select) electronic communications for the user and/or generate (or select) selectable graphical user interface options for a client device of the user (e.g., to enable quicker execution of or provide quicker access to a target outcome). Moreover, in some instances, the digital page sequence machine learning system utilizes predicted page sequences (of a user and other users) to segment users based on user navigation sessions similarities (e.g., a likelihood of visiting a particular page or performing particular target outcome) to display segmentation of users based on navigation session types, page categories, page products, and/or product brands.

In one or more implementations, the digital page sequence machine learning system trains a large language model to predict page sequences from user navigation session tokens utilizing a contrastive, page order agnostic measure of loss. For example, the digital page sequence machine learning system utilizes training input-output page sequence pairs to predict page sequences and generate a measure of loss using a rolling window of summed losses from a comparison of the predicted page sequences to the training input-output page sequence pairs (e.g., as ground truths). In one or more implementations, the digital page sequence machine learning system further utilizes a maximum and minimum rolling window of summed losses for a particular prediction to determines a custom, contrastive page order agnostic measure of loss from the predicted page sequence and ground truth comparisons. In addition, utilizes the contrastive, page order agnostic measure of loss to modify the parameters of the large language model.

The digital page sequence machine learning system can provide several advantages over conventional systems. As an example, the digital page sequence machine learning system improves the accuracy of digital page navigation predictions for users. For instance, by tokenizing structured page descriptor data that includes category and/or product page data for input into a large language model, the digital page sequence machine learning system improves the granularity of the predicted digital page navigation predictions generated for users. Indeed, the digital page sequence machine learning system further utilizes the granular predicted digital page navigation predictions to enhance the detail of several downstream user activity prediction tasks.

Moreover, the digital page sequence machine learning system also improves the efficiency of utilizing machine learning to predict digital user navigation behavior and to execute downstream applications using the predicted digital user navigation behavior. For instance, unlike many conventional systems that utilize different components or machine learning models to train (or generate) different inferences for downstream tasks, in one or more implementations the digital page sequence machine learning system utilizes the output predicted page sequence data from the singular large language model to execute a variety of downstream tasks.

In particular, due to the flexibility in input format and output format, the digital page sequence machine learning system enables the output predicted page sequence to be utilized by a variety of downstream tasks (with increased computational efficiency). In addition, the digital page sequence machine learning system also enables scalable utilization across multiple systems (due to the modifiable zero-shot and few-shot input format) with less configuration which enables efficient utilization of the large language model without significant modification to input formats and/or retraining. Therefore, unlike many conventional systems that utilize different models trained for individual tasks, in one or more implementations the digital page sequence machine learning system improves efficiency by enabling a singular large language model to generate predicted page sequences that are useable with a variety of downstream tasks. In addition, in one or more instances, the digital page sequence machine learning system utilizes widely available user navigation data (e.g., page URL visits) such that the digital page sequence machine learning system generates training data is easily obtainable and lightweight (e.g., to reduce computation time and storage space).

Furthermore, the digital page sequence machine learning system improves flexibility of digital user behavior prediction modeling. In particular, in one or more instances, the digital page sequence machine learning system utilizes readily available (and accessible) user navigation data (e.g., page visits) with a large language model to generate digital user navigation inferences. In addition, unlike many conventional systems that are limited to predetermined input formats and output formats, the digital page sequence machine learning system can utilize a large language model to generate predicted page sequences without a predetermined size of sequence. Moreover, in one or more implementations, the digital page sequence machine learning system utilizes a modifiable and size variable input prompt to generate the predicted page sequences to guide the large language model using past user activity data (e.g., user page visits data). Unlike conventional systems, the flexibility in input format and output format enables the digital page sequence machine learning system to scale to a wide variety of systems or use cases without significant modification of the input prompts and/or without retraining of the large language model.

Furthermore, unlike many conventional systems that are limited to utilizing document repositories when using large language model, the digital page sequence machine learning system can utilize tokens for page visit data instead of natural language input with a large language model to generate predicted user page sequences. Many conventional systems are unable to utilize large language models without using natural language prompts (making it difficult to scale in automated systems) due to the page sequence data not following natural language grammar. In contrast, in one or more implementations the digital page sequence machine learning system utilizes page visit data (e.g., page URLs) with large language models (via tokenized conversions) to generate predicted user navigation behavior.

In addition, the digital page sequence machine learning system can also guide large language models using past user navigation sessions (and in some cases other similar user navigation sessions from other users). This also enables the digital page sequence machine learning system to flexibly generate predicted page sequences for a wide variety of systems or use cases without significant modification of the input prompts and/or without retraining of the large language model. Furthermore, by utilizing a large language model, in one or more embodiments the digital page sequence machine learning model system enables user modification of input prompts to generate customized prompts to generate customized predicted page sequences without utilizing complicated query language, such as SQL queries (e.g., users utilize natural language input prompt modifications).

Moreover, the digital page sequence machine learning system can also improve the accuracy of utilizing machine learning to generate page sequence predictions. For example, the digital page sequence machine learning system utilizes specific zero-shot and few-shot input formats to increase the accuracy of large language models in predicting page sequences. In addition, in one or more instances, the digital page sequence machine learning system trains the large language model utilizing a custom loss that improves the accuracy of page sequence predictions by utilizing a page order agnostic measure that further accounts for both the most accurate and least accurate prediction matches (based on a contrastive loss). Indeed, the utilization of a contrastive loss attempts to minimize the minimum loss (e.g., to increase accuracy) while maximizing the maximum loss (to move predictions further away from dissimilar pages).

Moreover, in one or more implementations, the digital page sequence machine learning system is able to utilize available user navigation session history (e.g., past page visits) (and/or other user navigation session history) as part of the input prompt to build in context for the large language model to accurately generate an accurate predicted page sequence for a user. In many cases, the digital page sequence machine learning system results in predicted user interaction behaviors that are self-defined by user navigation data to generate proactive predictions on future user behavior. Indeed, in some cases, the digital page sequence machine learning system generates predicted page sequences from users without utilizing events attached to a cookie to personalize (e.g., cookieless personalization).

As used herein, the term “user navigation data” refers to information of user interactions with a website and/or digital application between one or more interfaces. For example, user navigation data includes page views, click paths, session durations, timestamps, exit pages, source of arrival data, time on page data, and/or click paths. In one or more instances, the user navigation data includes page view through page URL visits of users and timestamps for the user. In some cases, user navigation data includes video streaming views and/or other digital content views. In one or more instances, the digital page sequence machine learning model system identifies (or receives) user navigation data specific to a website or digital application to generate page visit, page sequence, and/or user navigation session token data for the particular website and/or digital application.

In addition, as used herein, the term “page visit” refers to an action denoting that a client device viewed or visited a particular page (or interface) corresponding to a particular URL. In one or more instances, a page visit includes a URL of the page and a timestamp indicating a time of visit by a client device corresponding to the user. In some cases, page visit data also includes user metadata (e.g., location data, browser data, operating system data).

Furthermore, as used herein, the term “user navigation session” refers to a sequence of page visits of a client device corresponding to a user. Indeed, in one or more embodiments, a user navigation session includes a sequence of page visits that represents or forms a user journey in one or more websites and/or digital applications. Indeed, as used herein, the term “page sequence” refers to a set of page visits by a client device corresponding to a user within a website and/or digital application. For example, the page sequence includes various numbers of page visits in chronological order or as an unordered set (indicating which pages were visited by a user during a navigation session).

As used herein, the term “user navigation session token” (or sometimes referred to as “session token”) refers to a unit of text that represents (portions of or an entirety of) page descriptors and/or source of arrival data for user navigation sessions (e.g., as sub-word level tokens). Indeed, in one or more cases, the digital page sequence machine learning system utilizes user navigation session tokens to break down page descriptors (e.g., a page name, page category, and/or product or content associated with a page) and/or source of arrival data (or other data) into smaller units for utilization in a large language model. For example, a user navigation session token includes one or more page tokens that represent an individual page, page category, and/or product or content associated with a page (e.g., sub-word level tokens that break the page name or the other descriptor into separate words or descriptors). Indeed, in one or more implementations, the digital page sequence machine learning model system represents a user navigation session by generating multiple user navigation session tokens that include a source of arrival token, beginning of session token, various sets of page tokens to represent one or more pages, intersession time tokens, and an end of session token. In one or more implementations, the digital page sequence machine learning model system utilizes a tokenizer to generate the user navigation session token(s). For instance, a tokenizer includes a model (e.g., machine learning, rule-based, tree-based), an algorithm, and/or a set of instructions that transform or convert page descriptors and/or other data (in accordance with one or more implementations herein) to sub-word level tokens.

As used herein, the term “language machine learning model” refers to a machine learning model that analyzes a language input (e.g., text or verbal input) to generate a predicted output. For instance, the digital page sequence machine learning system utilizes a variety of language machine learning model architectures, such as a large language model. For example, a large language model processes natural language text to generate outputs that range from predictive outputs and/or natural language analyses of the predictive outputs. In particular, in one or more implementations, a large language model includes a transformer neural network architecture having parameters trained (e.g., via deep learning) on data to learn patterns and rules of user page sequences to generate predicted page sequences. Examples of large language model include bidirectional encoder representations (BERT), Sentence-BERT, ChatGPT (e.g., GPT-3, GPT-4, etc.), Llama2, T5 encoder-decoder models, Mistral, Llama3, TinyLlama, other text transformer models, and/or other word processing machine learning models.

As used herein, the term “input prompt” refers to a set of input instructions to a large language model (or other machine learning model) to cause the large language model to generate a particular output (or perform a particular task). Indeed, in some cases, a prompt includes an input string of text that includes request for a large language model (e.g., to generate a predicted page sequence) with context from sample page sequences corresponding to the user and/or other users. In one or more cases, an input prompt includes a machine generated text input and/or a user generated text input or voice command. For instance, the digital page sequence machine learning model system utilizes a prompt generation model to generate an input prompt utilizing one or more prompt templates and/or user navigation session tokens in accordance with one or more implementations herein. For example, a prompt generation model includes a model (e.g., machine learning, rule-based, tree-based), an algorithm, and/or a set of instructions that transform or converts one or more prompt templates, user navigation session tokens, and/or other input descriptor (e.g., text or voice data) into an input prompt (in accordance with one or more implementations herein).

As used herein, the term “machine learning model” refers to a computer algorithm or a collection of computer algorithms that automatically improve for a particular task through experience based on use of data. For example, a machine learning model utilizes one or more learning techniques to improve in accuracy and/or effectiveness. Example machine learning models include various types of decision trees, support vector machines, Bayesian networks, linear regressions, logistic regressions, random forest models, time series model, pairwise products model, or neural networks. Indeed, in some instances, a machine learning model includes a transformer-based models (e.g., large language models), long short-term memory model, a convolutional neural network (CNN) model, or a recurrent neural network (RNN) model.

As used herein, the term “user activity prediction model” refers to a computer algorithm or a collection of computer algorithms that utilize input data to generate or determine one or more predicted user activities from the input data. For instance, the user activity prediction model includes a decision tree and/or other rule-based model that utilizes determined page sequence data to output predicted (or related) user activities. In one or more cases, the user activity prediction model includes machine learning models that analyze patterns in predicted page sequence data to infer or predict user activities (or insights).

As further used herein, the term “predicted user activity” refers to one or more actions and/or metrics corresponding to user behavior on a website and/or application. For example, a predicted user activity includes, but is not limited to, target predictions (e.g., predicted products for users, predicted categories for users, predicted journeys for users), page visit time predictions, user activity frequency predictions, target conversion outcome predictions, and/or forecasting predictions.

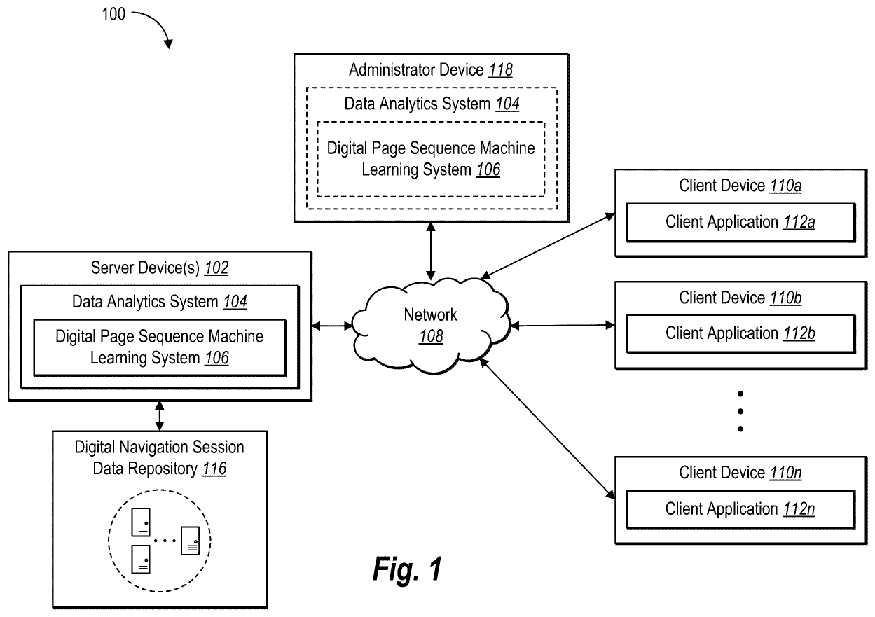

Turning now to the figures, FIG. 1 illustrates a schematic diagram of one or more implementations of a system 100 (or environment) in which a digital page sequence machine learning system operates in accordance with one or more implementations. As illustrated in FIG. 1, the system 100 includes a server device(s) 102, a network 108, a client devices 110a-110n, an administrator device 118, and digital navigation session data repository 116. As further illustrated in FIG. 1, the server device(s) 102, the client devices 110a-110n, the administrator device 118, and the digital navigation session data repository 116 communicate via the network 108.

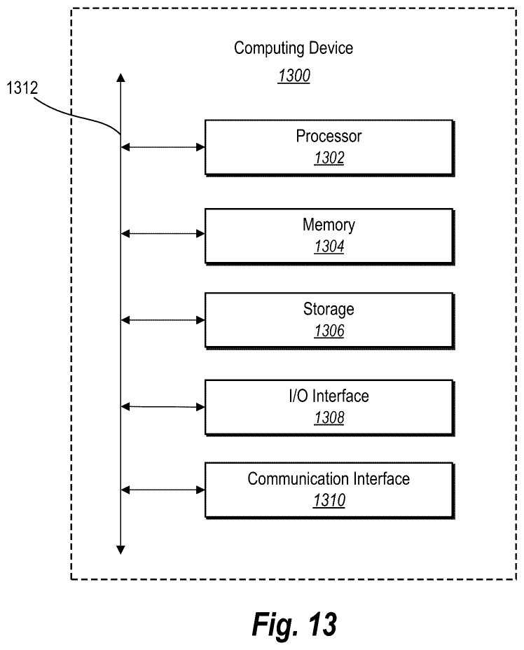

In one or more implementations, the server device(s) 102 includes, but is not limited to, a computing (or computer) device (as explained below with reference to FIG. 13). As shown in FIG. 1, the server device(s) 102 include a data analytics system 104 which further includes the digital page sequence machine learning system 106. The data analytics system 104 can generate, train, store, deploy, and/or utilize various machine learning models for various machine learning applications, such as, but not limited to, regression tasks, digital navigation behavior, classification tasks, text recognition tasks, voice recognition tasks, artificial intelligence tasks, and/or other data analytics tasks (e.g., conversion predictions, user affinity predictions, user-content affinity predictions, user-product affinity predictions). In addition, in one or more instances, the data analytics system 104 generates a variety of graphical user interfaces and/or digital content for the above-mentioned machine learning applications (and/or data analytics applications).

Furthermore, as explained below, the digital page sequence machine learning system 106, in one or more embodiments, utilizes digital page sequence data with a large language model to generate digital page navigation predictions for users and, subsequently, user activity predictions from the digital page navigation predictions. In one or more implementations, the digital page sequence machine learning system 106 generates input prompts from user navigation session tokens corresponding to a user navigation session of a user and utilizes the input prompt with a large language model to generate predicted page sequences. Moreover, in accordance with one or more implementations herein, the digital page sequence machine learning system 106 utilizes the predicted page sequences with a user activity prediction model to generate one or more predicted user activities for the user. Indeed, in one or more embodiments, the digital page sequence machine learning system 106 utilizes the predicted user activities to select (or generate) digital content for the client devices 110a-110n.

Furthermore, as shown in FIG. 1, the system 100 includes the client devices 110a-110n. In one or more implementations, the client devices 110a-110n includes, but is not limited to, a mobile device (e.g., smartphone, tablet), a laptop, a desktop, or any other type of computing device, including those explained below with reference to FIG. 13. In certain implementations, although not shown in FIG. 1, the client devices 110a-110n is operated by a user to perform a variety of functions (e.g., via a digital application). For example, the client devices 110a-110n performs functions such as, but not limited to, interacting with one or more graphical user interfaces for websites and/or applications, displaying media content items (e.g., images, videos, text), and/or enabling electronic communications. In some instances, the client devices 110a-110n also generate and/or provide data, such as, but not limited to user navigation data (e.g., click stream data, cookie data) to the server device(s) 102 (for utilizing by the data analytics system 104 and/or the digital page sequence machine learning system 106).

To view or access the functionalities or content generated the digital page sequence machine learning system 106 (as described above), in one or more implementations, a user interacts with the digital application on the client devices 110a-110n. For example, the digital application includes one or more software applications installed on the client devices 110a-110n (e.g., client applications 112a-112n) to perform functionalities, such as but not limited to, interacting with one or more graphical user interfaces for websites and/or applications, displaying media content items (e.g., images, videos, text), enabling electronic communications, and/or generating digital user navigation data in accordance with one or more implementations herein. In some cases, the digital applications (e.g., client applications 112a-112n) are hosted on the server device(s) 102. In addition, when hosted on the server device(s) 102, the client applications 112a-112n are accessed by the client devices 110a-110n through a web browser and/or another online interfacing platform and/or tool.

As further shown in FIG. 1, the system 100 includes the administrator device 118. In one or more implementations, the administrator device 118 includes, but is not limited to, a mobile device (e.g., smartphone, tablet), a laptop, a desktop, or any other type of computing device, including those explained below with reference to FIG. 13. In one or more implementations, although not shown in FIG. 1, the administrator device 118 is operated by an administrator user to perform a variety of functions (e.g., via a digital application). For instance, the administrator device 118 performs functions, such as, but not limited to, configuring various parameters of the digital page sequence machine learning system 106, configuring or implementing a large language model, configuring or implementing a user activity prediction model, and/or configuring digital navigation session data. Moreover, the administrator device 118 also performs functions, such as, but not limited to, displaying graphical user interfaces for predicted page sequences and/or predicted user activities, displaying graphical user interfaces for data analytics or reports generated from predicted page sequences and/or predicted user activities (in accordance with one or more implementations herein), and/or displaying graphical user interfaces to configure the various aspects of the data analytics system 104 and/or the digital page sequence machine learning system 106.

To view or access the functionalities or content generated by the digital page sequence machine learning system 106 (as described above), in one or more implementations, an administrator user interacts with an administrator digital application on the administrator device 118. For example, the administrator digital application includes one or more software applications installed on the administrator device 118 to perform the above-mentioned functionalities. In some cases, the administrator digital application is hosted on the server device(s) 102. In addition, when hosted on the server device(s) 102, the administrator digital application is accessed by the administrator device 118 through a web browser and/or another online interfacing platform and/or tool. In some cases, as shown in FIG. 1, the administrator device hosts or implements the data analytics system and/or the digital page sequence machine learning system 106.

Although FIG. 1 illustrates the digital page sequence machine learning system 106 being implemented by a particular component and/or device within the system 100 (e.g., the server device(s) 102), in some implementations, the digital page sequence machine learning system 106 is implemented, in whole or in part, by other computing devices and/or components in the system 100. For example, in some implementations, the digital page sequence machine learning system 106 is implemented on the administrator device 118. Indeed, in one or more implementations, the description of (and acts performed by) the digital page sequence machine learning system 106 are implemented (or performed by) administrator device 118 when the administrator device 118 implements the digital page sequence machine learning system 106. More specifically, in some instances, the administrator device 118 (via an implementation of the digital page sequence machine learning system 106 on a digital application of the administrator device 118) utilizes digital page sequence data with a large language model to generate digital page navigation predictions for users and various downstream user activity predictions from the digital page navigation predictions.

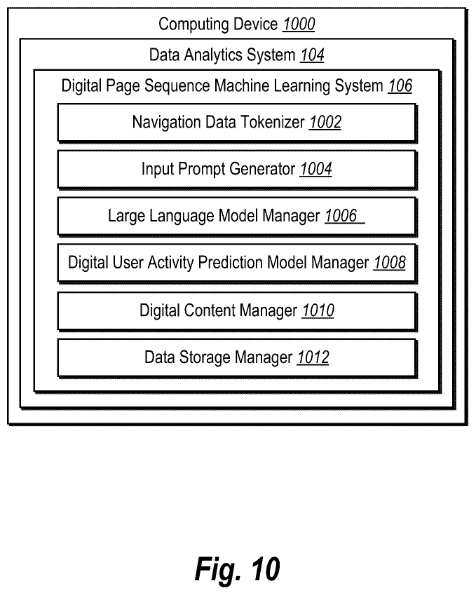

As further shown in FIG. 1, the system 100 includes a digital navigation session data repository 116. For instance, the digital navigation session data repository 116 includes one or more storage devices (or systems) that process, create, and/or store digital user activity (or navigation) data from the client devices 110a-110n. In some cases, the digital navigation session data repository 116 includes data received form the client devices 110a-110n. In some instances, the digital navigation session data repository 116 includes existing page sequence data (e.g., from an existing data set or training data set). For example, the digital navigation session data repository 116 includes historical navigation session data collected by the data analytics system 104 from user interactions received from the client devices 110a-110n and/or third-party digital navigation session data. In one or more implementations, the digital navigation session data repository 116 includes, but is not limited to, a computing (or computer) device (as explained below with reference to FIG. 10).

Additionally, as shown in FIG. 1, the system 100 includes the network 108. As mentioned above, in some instances, the network 108 enables communication between components of the system 100. In certain implementations, the network 108 includes a suitable network and may communicate using any communication platforms and technologies suitable for transporting data and/or communication signals, examples of which are described with reference to FIG. 10. Furthermore, although FIG. 1 illustrates the server device(s) 102, the client devices 110a-110n, the administrator device 118, and/or the digital navigation session data repository 116 communicating via the network 108, in certain implementations, the various components of the system 100 communicate and/or interact via other methods (e.g., the server device(s) 102 and the administrator device 118 communicating directly).

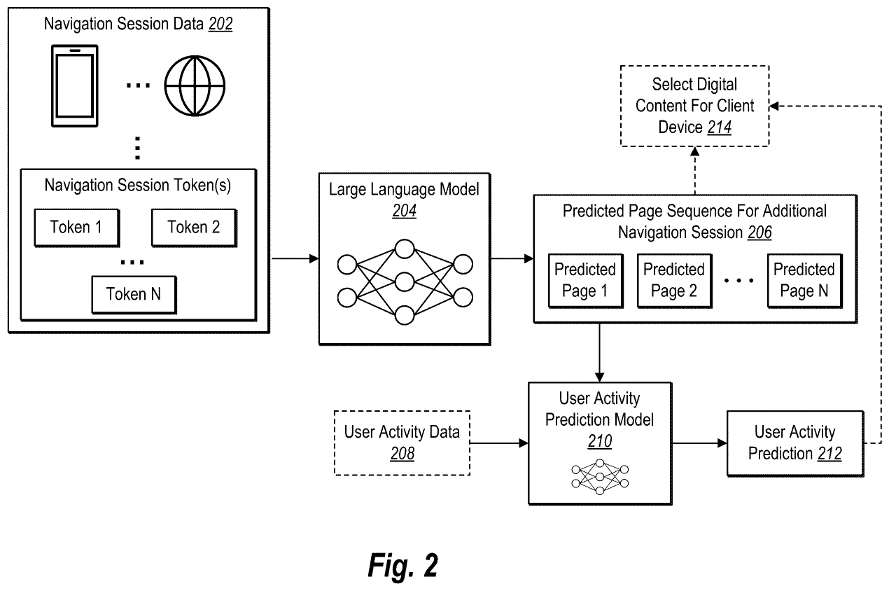

As mentioned above, in one or more instances, the digital page sequence machine learning system 106 utilizes tokenized page sequence data from navigation sessions with large language models to generate digital page navigation predictions and a variety of downstream user activity prediction tasks for client devices. For example, FIG. 2 illustrates an overview of the digital page sequence machine learning system 106 utilizing page sequence data with a large language model to generate predicted page sequences for additional navigation sessions for a user. In addition, FIG. 2 also illustrates an overview of the digital page sequence machine learning system 106 utilizing predicted page sequences to generate user activity predictions for a user.

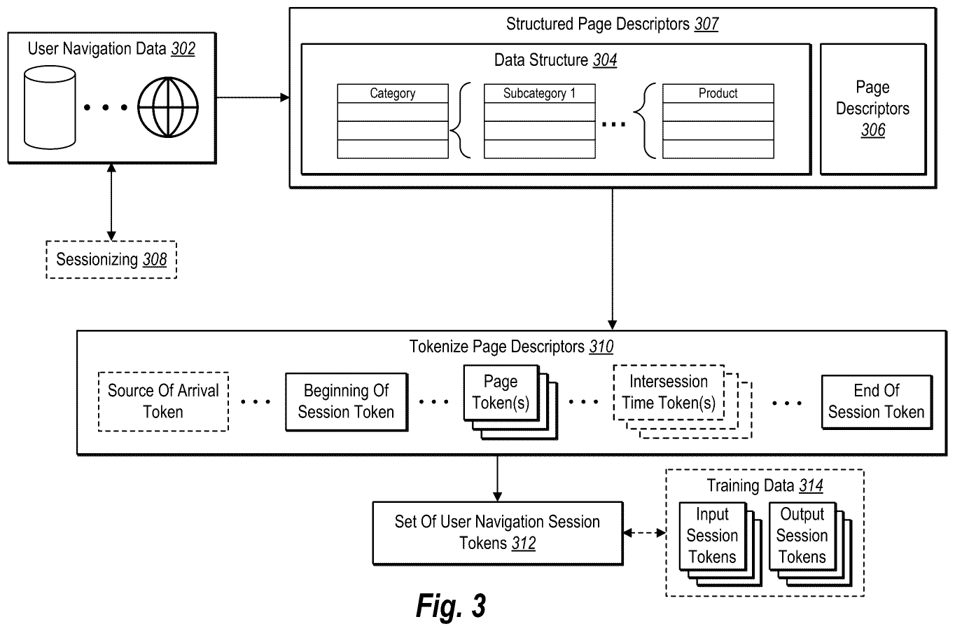

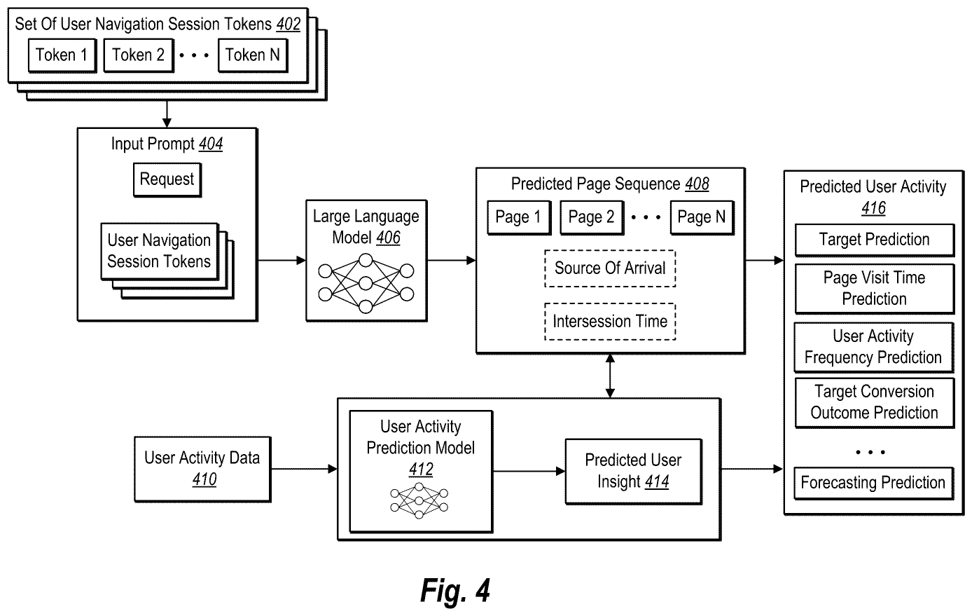

For example, as shown in FIG. 2, the digital page sequence machine learning system 106 identifies (or generates) navigation session data 202. In some cases, the digital page sequence machine learning system 106 identifies navigation session data from user interactions on a client device as page sequence descriptors. Moreover, in one or more instances, the digital page sequence machine learning system 106 tokenizes page sequence descriptors as the page user navigation session token(s). Indeed, the digital page sequence machine learning system 106 generates navigation session tokens as described below (e.g., in relation to FIG. 3). Moreover, as shown in FIG. 2, the digital page sequence machine learning system 106 utilizes the navigation session data 202 with a large language model 204 (e.g., via a generated input prompt that includes navigation session tokens and instructional text) to generate a predicted page sequence 206 for an additional navigation session (for a user of a client device). Indeed, the digital page sequence machine learning system 106 utilizes navigation session data 202 in an input prompt for a large language model to generate a predicted page sequence as described below (e.g., in relation to FIGS. 3 and 4).

In some implementations, as shown in an act 214 of FIG. 2, the digital page sequence machine learning system 106 utilizes the predicted page sequence 206 to select (or generate) digital content for a client device of the user. For instance, as mentioned above, the digital page sequence machine learning system 106 utilizes the predicted page sequences to select (or create) digital content for electronic communications for the user, selectable graphical user interface options for a client device of the user, and/or user segments based on user navigation session similarities.

Indeed, in one or more instances, the digital page sequence machine learning system 106 utilizes digital page sequence data with large language models to generate digital page navigation predictions for client devices as described in UTILIZING DIGITAL PAGE SEQUENCE TOKENS WITH LARGE LANGUAGE MODELS TO GENERATE DIGITAL CONTENT PREDICTIONS, U.S. patent application Ser. No. 18/829,774, filed Sep. 10, 2024 (hereinafter “application Ser. No. 18/829,774”), which is incorporated herein by reference in its entirety.

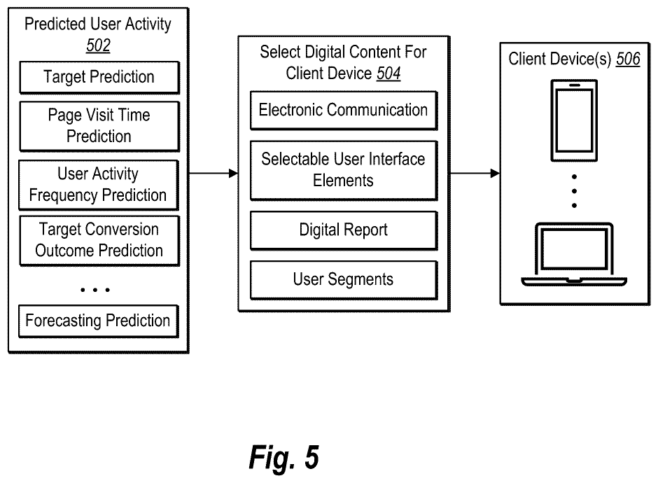

Furthermore, as shown in FIG. 2, the digital page sequence machine learning system 106 utilizes the predicted page sequence 206 with a user activity prediction model 210 to generate a user activity prediction 212. In particular, in one or more instances, the digital page sequence machine learning system 106 utilizes the predicted page sequence 206 with a downstream user activity prediction model 210 (that provides or generates a user activity insight) to derive or determine a particular user activity prediction 212 (e.g., a user behavior or insight that is customized to the predicted page sequence 206). In some instances, as shown in FIG. 2, the digital page sequence machine learning system 106 utilizes user activity data 208 with the user activity prediction model 210 to generate a user activity insight (e.g., a predicted behavior or other user activity metric) and utilizes a combination of the user activity insight and the predicted page sequence 206 to generate the user activity prediction 212 (e.g., as a user behavior or insight that is customized to the predicted page sequence 206). Indeed, the digital page sequence machine learning system 106 generates user activity predictions utilizing a predicted page sequence as described below (e.g., in relation to FIGS. 4 and 5).

Moreover, as shown in the act 214 of FIG. 2, in some cases, the digital page sequence machine learning system 106 also utilizes the user activity prediction 212 to select (or generate) digital content for a client device of the user. For example, the digital page sequence machine learning system 106 utilizes the user activity prediction 212 to select (or create) digital content for electronic communications for the user, selectable graphical user interface options for a client device of the user, and/or user segments based on user navigation session similarities. Indeed, the digital page sequence machine learning system 106 selects digital content for a client device of a user based on user activity prediction data as described below (e.g., in relation to FIGS. 5, 7, 8A-8C, and 9).

As mentioned above, in one or more instances, the digital page sequence machine learning system 106 tokenizes digital user navigation data. For instance, FIG. 3 illustrates the digital page sequence machine learning system 106 generating user navigation session tokens from digital user navigation data. In particular, FIG. 3 illustrates the digital page sequence machine learning system 106 identifying page sequence data from user navigation data, converting the page sequence data to page descriptors, and tokenizing the page descriptors to generate a set of user navigation tokens. In addition, FIG. 3 further illustrates the digital page sequence machine learning system 106 utilizing data schema structures that include page categories, subcategories, and/or product descriptors to tokenize user navigation data with category and/or product level description structure (e.g., to improve the accuracy of the large language model and training data for the large language model).

In one or more instances, the digital page sequence machine learning system 106 identifies (or receives) digital user navigation data (and generates page descriptors) from digital user activities on one or more websites or digital applications as described in application Ser. No. 18/829,774.

In some instances, for training data, the digital page sequence machine learning system 106 identifies training datasets of user navigation data as described in application Ser. No. 18/829,774. Additionally, in one or more implementations, the digital page sequence machine learning system 106 utilizes the data structure 304 to generate navigation session training data. Indeed, as shown in FIG. 3, the digital page sequence machine learning system 106 generates training data 314 (e.g., as pairings of input session tokens and output session tokens). In one or more instances, as shown in FIG. 3, the digital page sequence machine learning system 106 utilizes a data structure 304 with page descriptors 306 from the user navigation data 302 to generate page navigation sequences (e.g., user navigation session token sequences) that follow (or utilize) a category (and subcategory) and product structure (e.g., from structured page descriptors 307). In one or more instances, the digital page sequence machine learning system 106 utilizes page category and/or product level description of pages to generate page navigation sequences that function as accurate target labels for user activity insights from user journeys represented in page navigation sequences.

In addition to training data, as shown in FIG. 3, the digital page sequence machine learning system 106 utilizes data structure 304 with page descriptors 306 during inference to generate page descriptor tokens for user navigation session tokens (as input for a large language model). In particular, as shown in FIG. 3, the digital page sequence machine learning system 106 identifies (or receives) user navigation data 302. In some instances, the digital page sequence machine learning system 106 extracts (or identifies) page sequence data from the user navigation data 302 (e.g., as page URLs, page code). In addition, the digital page sequence machine learning system 106 converts the page sequence data to page descriptors 306 (e.g., a natural language descriptor for elements from the page sequence data). Moreover, as shown in FIG. 3, the digital page sequence machine learning system 106 further utilizes the page descriptors 306 with the data structure 304 (e.g., category, subcategory, product descriptor structures) to generate the structured page descriptors 307.

Indeed, as shown in FIG. 3, the digital page sequence machine learning system 106 utilizes the structured page descriptors 307 to generate tokens as user navigation session tokens. For example, as shown in an act 310 of FIG. 3, the digital page sequence machine learning system 106 tokenizes the structured page descriptors 307 from the user navigation data 302 (e.g., utilizing a tokenizer). Indeed, as shown in FIG. 3, the digital page sequence machine learning system 106 generates tokens from the structured page descriptors 307, such as a beginning of session token, page token(s), and an end of session token. In some instances, as shown in the act 310, the digital page sequence machine learning system 106 also generates a source of arrival token. Furthermore, as shown in FIG. 3, the digital page sequence machine learning system 106 also generates one or more intersession time tokens from the structured page descriptors 307. As shown in FIG. 3, the digital page sequence machine learning system 106 tokenizes the structured page descriptors 307 to generate a set of user navigation tokens 312.

In some instances, as shown in the act 308 of FIG. 3, the digital page sequence machine learning system 106 sessionizes user navigation data 302 (e.g., page sequence data from the user navigation data 302) to generate (or identify) separate user navigation sessions on a website and/or a digital application. For instance, the digital page sequence machine learning system 106 utilizes timestamp data corresponding to the page sequence data (e.g., timestamps for individual page URL visits) to determine a user navigation session. For instance, in some cases, the digital page sequence machine learning system 106 utilizes a threshold time gap between page URL visits to segregate sequences of page visits from the page sequence data into user navigation sessions. For example, the digital page sequence machine learning system 106 determines a sequence of page URL visits that, each, are within a threshold time gap apart to determine that the sequence of page URL visits belong to a singular user navigation session. Indeed, in one or more cases, the digital page sequence machine learning system 106 sessionizes user navigation data as described in application Ser. No. 18/829,774.

In one or more implementations, the digital page sequence machine learning system 106 generates page descriptors. For instance, the digital page sequence machine learning system 106 utilizes the page sequence data to generate page descriptors that map (or convert) the page URLs (or other page code) to readable, natural language descriptors. For example, the digital page sequence machine learning system 106 utilizes a mapping (e.g., a dictionary mapping) corresponding to a particular website and/or digital application between page URLs and a page name (or page title) to generate the page descriptors. For instance, the digital page sequence machine learning system 106 utilizes the page names or titles mapped to the page URLs as the page descriptors. As an example, the digital page sequence machine learning system 106 utilizes a mapping, from the website and/or digital application, that maps particular URLs to particular page names (e.g., www.companyl.com/% 4303/prd1/8484888 maps to “Product 1 Page” and www.companyl.com/% 4429/srv/maps to “Service Page”). Indeed, in one or more instances, the digital page sequence machine learning system 106 generates page descriptors as described in application Ser. No. 18/829,774.

Moreover, in one or more instances, the digital page sequence machine learning system 106 generates a page sequence by creating an order for the page descriptors based on a time stamp associated with the page descriptors (or the page URL visits). Indeed, in one or more cases, the digital page sequence machine learning system 106 generates the page sequence to indicate a user navigation journey (e.g., in a navigation session) that represents a path of page visits of a user (e.g., a browsing history) during the navigation session. Indeed, in one or more instances, the digital page sequence machine learning system 106 generates page sequences as described in application Ser. No. 18/829,774.

Furthermore, as shown in FIG. 3, the digital page sequence machine learning system 106, utilizing a tokenizer, tokenizes page descriptors (e.g., structured page descriptors 307) to generate user navigation tokens. For instance, the digital page sequence machine learning system 106 tokenizes page descriptors to improve efficient utilization of the page sequence data with large language models. For example, the digital page sequence machine learning system 106 tokenizes the page descriptors into tokens as input for a large language model.

To illustrate, in one or more implementations, the digital page sequence machine learning system 106 generates special tokens to represent a page sequence in a user navigation session. In one or more instances, the digital page sequence machine learning system 106 generates tokens to represent a user navigation session in a particular format that indicates a beginning of a session, page visits in a session, and/or an end of a session. In some cases, the digital page sequence machine learning system 106 also generates a source of arrival token to indicate a source page (or method) utilized to access or begin the user navigation session. In one or more embodiments, the digital page sequence machine learning system 106 also utilizes a variety of other tokens to represent one or more additional aspects of a user navigation session (e.g., scroll actions, click actions, inputs, refreshes). Indeed, in one or more instances, the digital page sequence machine learning system 106 tokenizes page descriptors (or structured page descriptors) as described in application Ser. No. 18/829,774.

In some instances, the digital page sequence machine learning system 106 generates an intersession time token as part of a page sequence. For example, the digital page sequence machine learning system 106 utilizes user navigation data (e.g., timestamps from the user navigation data) to identify time in between page navigations by a user client device. In addition, in one or more instances, the digital page sequence machine learning system 106 generates intersession time tokens that indicate a time in between navigation from a page to another page (e.g., between two or more page tokens).

As an example, the digital page sequence machine learning system 106 tokenizes a user navigation session (e.g., the structured page descriptors of a sequence of pages) utilizing the following token format: [SRC] source page [BOS] page 1 category-page 1 subcategory-page1 product-page2 category-page 2 product-page 2 brand-page 3 . . . pageK [EOS], in which [SRC] denotes arrival of source token (e.g., for a first page of a session or a referring source to enter the first page), [BOS] denotes a beginning of a session, and [EOS] denotes an end of a session. As another example, the digital page sequence machine learning system 106 generates a tokenized page sequences from page sequence data for one or more sessions (e.g., user navigation session tokens) using the following token format: [SRC] search engine name [BOS] construction tools-light brand HardwareCompany-cart [EOS]; [SRC] (direct) [BOS] electronics-smartphone brand-phone1-checkout-phone2-phone3-cart-purchase [EOS]; [SRC] referral [BOS] home-apparel-shoes-ShoeCompany shoel [EOS].

Moreover, in one or more instances, the user navigation session tokens include a variety of outcome tokens. For instance, the user navigation session tokens include one or more conversion outcome tokens, such as, but not limited to, an add-to-cart token, a checkout token, and/or a purchase token. Indeed, in one or more instances, the digital page sequence machine learning system 106 tokenizes a user navigation session with structured page descriptors (as described above) and one or more conversion outcome tokens to generate a set of user navigation session tokens to represent a user navigation session.

Additionally, in one or more implementations, the digital page sequence machine learning system 106 generates user navigation tokens from page sequence data for a plurality of users over a plurality of identified navigation sessions for the plurality of users. Furthermore, as shown in FIG. 3, in some instances (and as mentioned above), the digital page sequence machine learning system 106 utilizes a data set of user navigation tokens (e.g., generated from structured page descriptors 307) to generate the training data 314. For instance, the digital page sequence machine learning system 106 utilizes tokens corresponding to multiple navigation sessions of one or more users to generate input session tokens (e.g., one or more test or training user navigation session token sequences) and ground truth output session tokens (e.g., one or more ground truth outcome user navigation session token sequences).

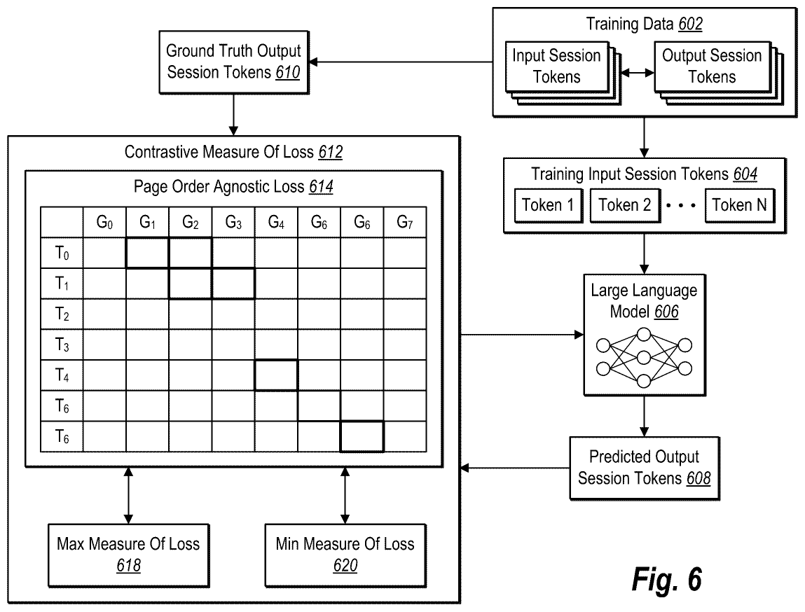

Indeed, in one or more instances, the digital page sequence machine learning system 106 utilizes the training data 314 to provide sample training examples of user navigation session(s) (via the input session tokens) and resulting additional user navigation session(s) (via the output input session tokens) in context of the input session tokens (e.g., for users). Indeed, the digital page sequence machine learning system 106 generates multiple training data pairs (e.g., training input-output page sequence pairs) from user navigation data from a plurality of users interacting with a variety of websites and/or digital applications. In some cases, the digital page sequence machine learning system 106 utilizes the training data 314 (e.g., the training input-output page sequence pairs) to generate few-shot prompts for a large language model and/or train a large language model to predict page sequences for users as described in application Ser. No. 18/829,774 and FIG. 6 below.

As mentioned above, in one or more implementations, the digital page sequence machine learning system 106 utilizes a large language model as a base model to generate and utilize digital page navigation predictions with a variety of downstream user activity prediction tasks. For example, FIG. 4 illustrates the digital page sequence machine learning system 106 generating an input prompt from user navigation session tokens for a large language model. In addition, FIG. 4 illustrates the digital page sequence machine learning system 106 utilizing the input prompt with the large language model to generate a predicted page sequence. Additionally, FIG. 4 illustrates the digital page sequence machine learning system 106 utilizing the predicted page sequence with a user activity prediction model to generate a predicted user activity.

As shown in FIG. 4, the digital page sequence machine learning system 106 generates an input prompt 404 from a set of user navigation session tokens 402 (generated as described above). For example, the digital page sequence machine learning system 106 generates the input prompt 404 by generating a portion of the prompt using the user navigation session token(s) from the set of user navigation session tokens 402 that represent one or more user navigation sessions of a user. For instance, the digital page sequence machine learning system 106 utilizes the portion of the prompt with the user navigation session token(s) to provide context to the large language model for one or more existing (or identified) user navigation sessions of the user.

In addition, as shown in FIG. 4, the digital page sequence machine learning system 106 also generates the input prompt 404 by generating a portion of the prompt using a request. For instance, the digital page sequence machine learning system 106 generates a request (e.g., using instruction text) to instruct (or prompt) the large language model to generate a predicted page sequence for a user by utilizing the provided user navigation session token(s) as context for the user's navigation sessions. For instance, the digital page sequence machine learning system 106 generates the request portion of the input prompt with instructional text requesting to generate the predicted page sequence based on input sessions represented by the user navigation session token(s).

Furthermore, as shown in FIG. 4, the digital page sequence machine learning system 106 utilizes the input prompt 404 with a large language model 406 to generate a predicted page sequence 408. As shown in FIG. 4, the digital page sequence machine learning system 106 utilizes the large language model 406 with the input prompt 404 to generate a sequence of page navigations (e.g., Page 1, Page 2, . . . , Page N) as the predicted page sequence 408 for a user corresponding to the user navigation session tokens from the input prompt 404. Indeed, in one or more instances, the large language model 406 generates an output predicted page sequence as, but not limited to, a sequence of user navigation session tokens, a sequence of page descriptors, and/or a sequence of page data (e.g., page URLs).

As further shown in FIG. 4, the digital page sequence machine learning system 106 utilizes the large language model 406 with the input prompt 404 to generate a predicted source of arrival as part of the predicted page sequence 408. Additionally, as also shown in FIG. 4, the digital page sequence machine learning system 106 utilizes the large language model 406 with the input prompt 404 to generate an intersession time indicating predicted times between page visits from the predicted pages (e.g., an intersession time as described above). In some cases, the digital page sequence machine learning system 106 also utilizes the large language model 406 with the input prompt 404 to generate a target outcome (e.g., exit website action, conversion, add-to-cart action, viewing a digital content item (video, image)) as part of the predicted page sequence 408.

In addition, as shown in FIG. 4, the digital page sequence machine learning system 106 utilizes the predicted page sequence 408 with a user activity prediction model 412 to generate a predicted user activity 416. For example, in one or more instances, the digital page sequence machine learning system 106 determines a predicted user insight 414 from a user activity prediction model 412 (based on user activity data 410). Moreover, the digital page sequence machine learning system 106 utilizes the predicted user insight 414 with the predicted page sequence 408 to determine the predicted user activity 416. In some cases, the digital page sequence machine learning system 106 utilizes the predicted page sequence 408 with the user activity prediction model 412 to generate the predicted user activity 416. For example, as shown in FIG. 4, the digital page sequence machine learning system 106 generates the predicted user activity 416 as, but not limited to, a target prediction, a page visit time prediction, a user activity frequency prediction, a target conversion outcome prediction, and/or a forecasting prediction.

In one or more instances, the digital page sequence machine learning system 106 generates a zero-shot and/or few-shot input prompt for a large language model to generate predicted page sequences from input user navigation session tokens. For instance, the digital page sequence machine learning system 106 generates a zero-shot input prompt for a large language model utilizing request instructions and user navigation session tokens of a user (e.g., utilizing a prompt generation model). In particular, in one or more embodiments, the digital page sequence machine learning system 106 generates an input prompt that includes sets of user navigation session tokens for one or more sample input user navigation sessions with a request to generate a predicted page sequence for a user by utilizing the provided user navigation session token(s) as context for the user's navigation sessions. As an example, the digital page sequence machine learning system 106 generates a zero-shot input prompt for the large language model utilizing the following template:

| | |
|---|---|
| ### Instructions: | |
| {sample - instruction} | |
| ### Input: | |
| Given sessions: | (1) |
| {sample - input} | |
| ### Response: | |
| Next Session: | |

As an example, in the above mentioned template (1), the digital page sequence machine learning system 106 generates an exemplary input prompt of “A user's website browsing sequence of pages over multiple sessions is given below. [SRC] denotes the source of session, [BOS] denotes beginning of session, [EOS] denotes end of session. Based on activity in the Given sessions, predict the Next session as a sequence of pages in the same format. Start with [SRC], end at [EOS]. No additional text.”

Although a particular example and template is illustrated above, in one or more instances, the digital page sequence machine learning system 106 utilizes various templates and/or input prompts, as zero-shot input prompts with the one or more sample input user navigation sessions, with a large language model to generate predicted page sequences for a user. For example, the digital page sequence machine learning system 106 utilizes various numbers of sample input user navigation sessions in an input prompt.

In some implementations, the digital page sequence machine learning system 106 generates a few-shot input prompt for a large language model utilizing request instructions, user navigation session tokens of a user, and one or more training user navigation session tokens (e.g., utilizing a prompt generation model). For example, the digital page sequence machine learning system 106 generates an input prompt that includes sets of user navigation session tokens for one or more sample input user navigation sessions of a user, one or more additional training input-output page sequence pairs (e.g., as described in application Ser. No. 18/829,774) with a request to generate a predicted page sequence for a user by utilizing the provided user navigation session token(s) as context for the user's navigation sessions and the one or more additional training input-output page sequence pairs as context on outputs. As an example, the digital page sequence machine learning system 106 generates a few-shot input prompt for the large language model utilizing the following template:

| | |
|---|---|
| {sample - instruction} | |
| Input: {Similar input - 1} | |
| Output: {output - 1} | |
| Input: {Similar input - 2} | |
| Output: {output - 2} | (2) |
| Input: {Similar input - 3} | |
| Output: {output - 3} | |
| Predict next session for user Input: {sample - input} | |
| Output: | |

As an example, in the above mentioned template (2), the digital page sequence machine learning system 106 generates an exemplary input prompt of “A user's website browsing sequence of pages over multiple sessions is given as Input. [SRC] denotes the source of session, [BOS] denotes beginning of session, [EOS] denotes end of session. Based on activity in the given input sessions, predict the next session as a sequence of pages highly likely to be visited by the user. Learn from similar users' browsing sequences given below.”

Although a particular example and template is illustrated above, in one or more instances, the digital page sequence machine learning system 106 utilizes various templates, input prompts, and/or training input-output page sequence pairs, as few-shot input prompts with the one or more sample input user navigation sessions, one or more training input-output page sequence pairs with a large language model to generate predicted page sequences for a user. For example, the digital page sequence machine learning system 106 utilizes various numbers of sample input user navigation sessions (of the user) and/or training input-output page sequence pairs in an input prompt.

Indeed, in one or more implementations, the digital page sequence machine learning system 106 utilizes zero-shot input prompts as described in application Ser. No. 18/829,774. Moreover, in one or more instances, the digital page sequence machine learning system 106 utilizes few-shot input prompts with sample input user navigation sessions (from the user and/or selected via similarity measures of word embeddings of training input-output page sequence pairs) as described in application Ser. No. 18/829,774.

Although one or more embodiments illustrate the digital page sequence machine learning system 106 generating a single predicted page sequence from user page sequence data of a user, in one or more instances, the digital page sequence machine learning system 106 utilizes the large language model with input prompts generated for particular user navigation session tokens created from interactions between one or more users on one or more websites and/or digital applications (for various navigation sessions) to generate predicted page sequences for individual users and/or an aggregate of users.

In one or more implementations, the digital page sequence machine learning system 106 utilizes a predicted page sequence with a user activity prediction model to generate a predicted user activity. In particular, in one or more instances, the digital page sequence machine learning system 106 utilizes a predicted page sequence as input for a user activity prediction model (e.g., a machine learning model, a regression model, a decision tree) to determine a predicted user activity. In some cases, the user activity prediction model analyzes the predicted page sequence and selects one or more predicted user activities based on a mapped association between pages in the predicted page sequences and potential user activities corresponding to the predicted pages in the predicted page sequences. In some instances, the user activity prediction model analyzes a predicted page sequences to generate probabilistic user activity outcomes for the predicted page sequences (e.g., via machine learning).

In some implementations, the digital page sequence machine learning system 106 utilizes the user activity prediction model to generate a predicted user insight from user activity data. As an example, a predicted user insight includes statistics or metrics (e.g., monetary values, time, affinities, recency, frequency) of a user in relation to web browsing behavior and/or content or product consumption behavior (online or offline). In some cases, the predicted user insight includes predicted navigation times and/or consumption metrics that indicate a user's value or potential to consume content and/or products. Moreover, in one or more cases, the digital page sequence machine learning system 106 utilizes the predicted page sequence to inform the predicted user insight from the user activity prediction model to generate the user activity data.

For example, as shown in FIG. 4, the digital page sequence machine learning system 106 generates a target prediction as the predicted user activity 416. In particular, in one or more instances the digital page sequence machine learning system 106 generates predicted page visits as the target prediction (for a particular user and/or a group of users). For instance, the digital page sequence machine learning system 106 utilizes a predicted page sequence (with a user activity prediction model and/or directly from the predicted page sequence) to determine a potential page visit in a future session (for a particular user and/or a group of users). In some cases, the digital page sequence machine learning system 106 utilizes the (structured) predicted page sequence data (based on the data structure described in FIG. 3) to determine predicted future product page visits. Indeed, in one or more instances, the digital page sequence machine learning system 106 utilizes the product page visits represented in predicted page sequence data as a representation of product interest for a user or multiple users of a website and/or application (e.g., a potential product conversion).

In addition, in one or more instances, the digital page sequence machine learning system 106 utilizes the (structured) predicted page sequence data (based on the data structure described in FIG. 3) to determine predicted category page visits (for a particular user and/or a group of users). Moreover, in one or more implementations, the digital page sequence machine learning system 106 utilizes the category page visits represented in predicted page sequence data as a representation of interest in a particular category for a user.

In some instances, the digital page sequence machine learning system 106 utilizes the (structured) predicted page sequence data to determine one or more target outcomes. For example, the digital page sequence machine learning system 106 determines a variety of outcome tokens from the predicted page sequence data as a predicted user activity. For instance, the digital page sequence machine learning system 106 determines one or more conversion outcome, such as, but not limited to, an add-to-cart outcome, a checkout outcome, and/or a purchase outcome from the predicted page sequence data (e.g., via a presence of a conversion outcome token as described above).

Moreover, in one or more implementations, the digital page sequence machine learning system 106 utilizes the (structured) predicted page sequence data to determine a predicted navigation journey for one or more users. For example, the digital page sequence machine learning system 106 utilizes a user activity prediction model with the predicted page sequence data to determine page sequences likely to be visited by various users (based on one or more predicted page sequences). In particular, the digital page sequence machine learning system 106 generates (or determines) a predicted navigation journey that applies to a user or holistically for multiple users by predicting from one or more predicted page sequences (of the large language model) a likely user navigation session for users on a website and/or electronic application. Indeed, in one or more implementations, the digital page sequence machine learning system 106 determines predicted navigation journeys of various length form predicted page sequence data generated by a large language model in accordance with one or more implementations herein.

Moreover, the digital page sequence machine learning system 106 utilizes the target predictions (as described above) determined for particular users and/or a group of users to generate predictive targeting data. For instance, the digital page sequence machine learning system 106 determines users or a group of users to target based on the target predictions (e.g., predicted page visits, predicted category visits, predicted outcomes, and/or predicted navigation journeys).

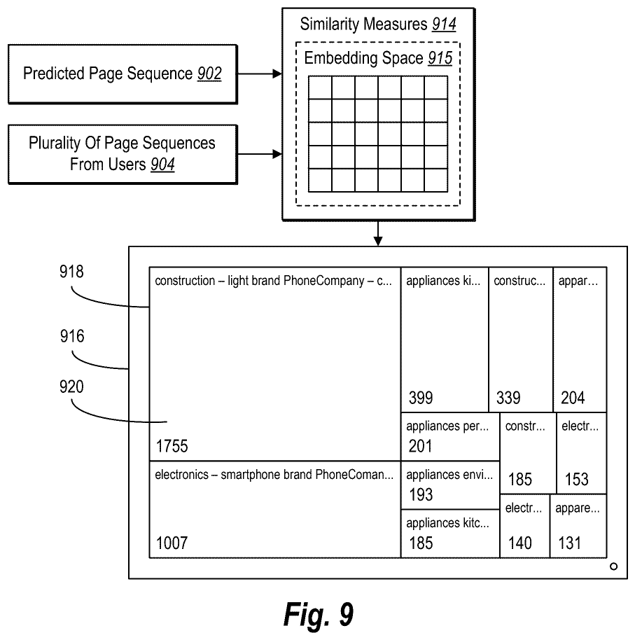

In addition, in one or more instances, the digital page sequence machine learning system 106 utilizes the predicted page sequence data with a user activity prediction model to generate segmentation data for users. In particular, in one or more implementations, the digital page sequence machine learning system 106 generates predictive segmentation data that reflects user groupings based on predicted page visit behaviors and/or other navigation interactions indicated by predicted page sequence data corresponding to the users. Indeed, in one or more embodiments, the digital page sequence machine learning system 106 generates predictive segmentation data as described in greater detail below (e.g., in reference to FIG. 9).

In some implementations, the digital page sequence machine learning system 106 utilizes predicted page sequence data (as described above) with a user activity prediction model to generate page visit time predictions. For example, in one or more instances, the digital page sequence machine learning system 106 utilizes, as a user activity prediction model, an inter-visit time model trained (or configured) to predict future time-instances of a future visit by one or more users (e.g., as a predicted user insight). Moreover, in one or more embodiments, the digital page sequence machine learning system 106 utilizes the predict future time-instances for particular users combined with specific predicted pages (e.g., category pages, product pages, checkout or cart pages) to determine a target time of visit to a particular page from the predicted page sequence data (e.g., a likely time of purchase, a likely time of visiting a particular product). Indeed, in one or more instances, the digital page sequence machine learning system 106 utilizes the page visit time predictions to select digital content (e.g., electronic communications) to transmit to particular users with messaging informed by the page visit time predictions (and conversion probabilities).

In addition, in one or more embodiments, the digital page sequence machine learning system 106 utilizes predicted page sequence data (as described above) with a user activity prediction model to generate user activity frequency predictions. For instance, the digital page sequence machine learning system 106 utilizes, as a user activity prediction model, a consumption metric prediction model (e.g., a user lifetime value (CLTV or LTV)) to generate predicted consumption metrics for one or more user as a predicted user insight. Indeed, in one or more instances, the digital page sequence machine learning system 106 utilizes the consumption metric prediction model to determine projected consumption rates or values (e.g., a lifetime monetary spend value) corresponding to users. Furthermore, in one or more instances, the digital page sequence machine learning system 106 utilizes predicted page sequence data to inform the consumption metrics. In particular, in one or more cases, the digital page sequence machine learning system 106 utilizes the predicted page sequence data to differentiate between users having similar consumption metrics (e.g., users likely to consume fewer, higher priced products versus users likely to consume a high amount of lower priced products). Indeed, in one or more instances, the digital page sequence machine learning system 106 utilizes the user activity frequency predictions to select digital content (e.g., electronic communications) to transmit to particular users with messaging informed by the user activity frequency predictions.

Additionally, in some instances, the digital page sequence machine learning system 106 utilizes predicted page sequence data (as described above) with a user activity prediction model to generate forecasting predictions. As an example, the digital page sequence machine learning system 106 utilizes predicted page sequence data to determine forecasted demand for particular products (e.g., products of a particular brand and/or of various brands) and/or product categories as user activity predictions. Moreover, in one or more instances, the digital page sequence machine learning system 106 utilizes the determined forecast demand (e.g., user activity predictions) with inventory forecasting models to generate a predicted inventory of a website (and/or application). In some cases, the digital page sequence machine learning system 106 utilizes the determined forecast demand (e.g., user activity predictions) with inventory forecasting models to determine predicted online and/or offline inventories based on the user activity predictions.

Additionally, in one or more instances, the digital page sequence machine learning system 106 utilizes predicted user activity data (and/or predicted page sequence data) to select digital content for a client device corresponding to one or more users. For instance, FIG. 5 illustrates the digital page sequence machine learning system 106 utilizing predicted user activity to select (or generate) digital content for one or more client devices. In particular, FIG. 5 illustrates the digital page sequence machine learning system 106 utilizing a predicted user activity (generated in accordance with one or more implementations herein) to select (or generate) digital content to execute or implement a wide variety of downstream digital user navigation recommendation and/or downstream digital marketing tasks in relation to one or more users or client devices.

For instance, as shown in an act 504 of FIG. 5, the digital page sequence machine learning system 106 utilizes a predicted user activity 502 (e.g., a target prediction, a page visit time prediction, user activity frequency prediction, target conversion outcome prediction, forecasting prediction) to select digital content for a client device. Indeed, as shown in FIG. 5, the digital content includes electronic communications, selectable user interface elements, digital reports, and/or a segment of users. As illustrated in FIG. 5, the digital page sequence machine learning system 106 provides (or transmits) the selected digital content to a client device(s) 506 of the user corresponding to the predicted user activity 502.

For example, in one or more implementations, the digital page sequence machine learning system 106 selects (or generates) electronic communications based on the predicted user activity. For instance, upon determining that a target product page or category page (e.g., a specific product page or conversion page) is predicted to be visited by a user in a navigation session, the digital page sequence machine learning system 106 (and/or the data analytics system 104) generates an electronic communication (e.g., email, message, popup) to the client device of the user to positively reinforce a potential conversion toward the target page. For example, the digital page sequence machine learning system 106 (and/or the data analytics system 104) transmits an electronic communication to advertise the target page and/or incentivize the target page and/or initiates an electronic communication with a service representative (e.g., a chat bot or service agent) to assist a user to the target page.

Additionally, the digital page sequence machine learning system 106 utilizes the predicted user activity to select (or generate) selectable user interface elements. For instance, the digital page sequence machine learning system 106 utilizes the predicted user activity to select a particular user interface element that enables quicker (or direct) navigation to a target page (or target outcome action) within the predicted user activity (e.g., a target prediction, page visit time prediction, and/or target conversion outcome prediction). In some cases, the digital page sequence machine learning system 106 (and/or the data analytics system 104) provides, for display within a graphical user interface of the client device, the selected user interface element to enable access to the target page (or target outcome action) within the predicted page sequence. For instance, the digital page sequence machine learning system 106 (and/or the data analytics system 104) displays the selected user interface element within an electronic communication, within a website page, and/or within a graphical user interface of a digital application.

In one or more implementations, the digital page sequence machine learning system 106 (and/or the data analytics system 104) utilizes the predicted user activity to generate digital reports. For instance, the digital page sequence machine learning system 106 generates digital reports to present statistics of target predictions, page visit time predictions, user activity frequency predictions, target conversion outcome predictions and/or forecasting predictions (as described herein). As an example, the digital page sequence machine learning system 106 generates digital reports for, but not limited to, conversion statistics, target outcome or target page visit statistics (e.g., a probable number of users visiting over a time period), and/or user segmentations determined from the predicted user activity (as described below). Indeed, in one or more instances, the digital page sequence machine learning system 106 generate digital reports for specific users and/or aggregated reports for multiple users.

In some cases, the digital page sequence machine learning system 106 (and/or the data analytics system 104) utilizes the predicted user activity to dynamically adjust or configure marketing campaigns (e.g., adjust or configure resources utilized in particular marketing campaigns, such as, but not limited to, search engine optimization bids, advertisement banner bids, frequency of referral and/or other electronic communication transmittals).

Moreover, in some instances, the digital page sequence machine learning system 106 utilizes predicted target outcomes to initiate a particular action to facilitate and/or increase the likelihood of the target outcome. For instance, the digital page sequence machine learning system 106 (and/or the data analytics system 104) selects (or transmits) electronic communications and/or displays selectable user interface elements corresponding to the predicted target outcome (e.g., a selectable interface element to navigate to checkout, a selectable interface element to initiate an electronic communication with customer service, an electronic communication reminding a user of an add-to-cart action). Furthermore, in some cases, the digital page sequence machine learning system 106 also dynamically adjusts or configures marketing campaigns (e.g., adjust or configure resources utilized in particular marketing campaigns, such as, but not limited to, search engine optimization bids, advertisement banner bids, frequency of referral and/or other electronic communication transmittals) based on the predicted target outcomes for the user.

Furthermore, in one or more embodiments, the digital page sequence machine learning system 106 utilizes the predicted user activity to generate (or select), as digital content, one or more digital recommendations. For instance, the digital page sequence machine learning system 106 utilizes predicted user activity (e.g., a target prediction, a page visit time prediction, a user activity frequency prediction, a target conversion outcome prediction) to generate recommendations for one or more users. For instance, by determining product and/or category specific interactions from the predicted user activity, the digital page sequence machine learning system 106 generates recommendations that capture context for product and/or brand browsing behaviors. In addition, the digital page sequence machine learning system 106 generates recommendations (e.g., product recommendations, category recommendations) to one or more users based on the predicted user activity (determined in accordance with one or more implementations herein). In some cases, the digital page sequence machine learning system 106 utilizes the predicted user activity to generate recommendations (as described above) at one or more downstream applications (e.g., a recommendation system, an electronic advertisement banner, a search engine).

Moreover, as illustrated in FIG. 5, the digital page sequence machine learning system 106 also utilizes the predicted user activity to generate user segments. In particular, in one or more instances, the digital page sequence machine learning system 106 utilizes predicted user activities of the user and additional users to segment users into groups (e.g., groups of similar navigation sessions). Indeed, in some cases, the digital page sequence machine learning system 106 generates user segments for users corresponding to one or more similar predicted user activities.

In some instances, the digital page sequence machine learning system 106 utilizes predicted page sequence data (generated in accordance with one or more implementations herein) to select digital content as described in application Ser. No. 18/829,774.

In one or more instances, the digital page sequence machine learning system 106 trains a large language model to generate predicted page sequences. For instance, FIG. 6 illustrates the digital page sequence machine learning system 106 training a large language model to generate predicted page sequences. In particular, FIG. 6 illustrates the digital page sequence machine learning system 106 training a large language model to generate predicted page sequences utilizing training input and output session tokens utilizing a contrastive, page order agnostic loss.

As shown in FIG. 6, the digital page sequence machine learning system 106 identifies training input session tokens 604 from the training data 602 (of training input-output page sequence pairs). Additionally, as illustrated in FIG. 6, the digital page sequence machine learning system 106 utilizes the training input session tokens 604 with a large language model 606 (in accordance with one or more implementations herein) to generate predicted output session tokens 608.

Furthermore, as shown in FIG. 6, the digital page sequence machine learning system 106 determines a contrastive measure of loss 612 for the predicted output session tokens 608. In particular, as shown in FIG. 6, the digital page sequence machine learning system 106 compares the predicted output session tokens 608 to ground truth output session tokens 610 corresponding to the training input session tokens 604 (from the training data 602) to generate the contrastive measure of loss 612. Indeed, in one or more instances, the digital page sequence machine learning system 106 utilizes the contrastive measure of loss 612 to modify parameters of the large language model 606. In one or more implementations, the digital page sequence machine learning system 106 utilizes measures of losses between predicted outputs and ground truth outputs iteratively to learn (or modify) parameters of the large language model 606 to accurately generate predicted page sequences (e.g., by reducing or minimizing the contrastive measure of loss 612).

Indeed, as shown in FIG. 6, the digital page sequence machine learning system 106 determines a page order agnostic loss 614 and utilizes max measures of loss 618 and min measures of loss 620 to determine the contrastive measure of loss 612. In particular, in one or more instances, the digital page sequence machine learning system 106 determines a page order agnostic loss that matches predicted pages in a page sequence (e.g., output session tokens for predicted pages) regardless of order in the predicted page sequence and the ground truth target page sequence (e.g., the ground truth output session tokens) to obtain a non-zero value of loss as described in greater detail below (e.g., with reference to function (4)). Furthermore, the digital page sequence machine learning system 106, in one or more instances, utilizes a maximum sum of rolling window losses and a minimum sum of rolling window losses from a comparison of the predicted page sequences to the training input-output page sequence pairs (e.g., as ground truths) to generate the contrastive measure of loss 612 (from the page order agnostic losses) as described in greater detail below (e.g., with reference to function (7)).

As mentioned above, the digital page sequence machine learning system 106 utilizes a measure of loss to modify a large language model. In one or more instances, the digital page sequence machine learning system 106 utilizes a measure of loss between a ground truth sequence of session tokens and a probability distribution generated by the large language model for a set of session tokens (e.g., in a vocabulary of the large language model based on the training data 602). For instance, the digital page sequence machine learning system 106, considering sequences of sessions (where each session is a sequence of pages), encodes a user target text (sequence of pages in an additional or next session) as a sequence of input tokens with IDs: [symbol] =[T₁, T₂, T₃, . . . , Tₘ] in which m is the maximum sequence length (e.g., ground truth output session tokens).

In some cases, the digital page sequence machine learning system 106 utilizes a grouping of tokens to represent a page in a sequence of pages. For example, in one or more implementations, the digital page sequence machine learning system 106 represents an r^{th} page in the n^{th} user (sample) as P_{n,r} and represents a number of tokens encoding page P_{n,r} as t_{n,r} (where r≥1 and t_{n,0}=0). In addition, in one or more instances, the digital page sequence machine learning system 106 represents sub-sequences of tokens representing a page as P_{n,r}:[T₍ₜ_{_{n,r-1}}₎₊₁, . . . , T₍ₜ_{_{n,r-1}}₎₊₍ₜ_{_{n,r}}₎], where (t_{n,r-1})+ (t_{n,r})≤m.

In one or more instances, the digital page sequence machine learning system 106 utilizes a large language model to generate a sequence of session tokens in the form of probability distributions. Indeed, in one or more instances, the digital page sequence machine learning system 106 represents the probability distributions of the predicted sequence of session tokens as [symbol] 32 [G₁, G₂, G₃, . . . , Gₘ], where each G_{i∈{1, 2, . . . , m}} is a probability distribution over the set of session tokens in a vocabulary of the large language model (e.g., based on the training data 602). In one or more implementations, to generate a measure of loss, the digital page sequence machine learning system 106 computes the sum of negative log-likelihoods (NLL) between ground truth output session tokens (for the training input tokens) and generated predicted session tokens at the corresponding positions. In particular, in one or more instances, the digital page sequence machine learning system 106 computes a measure of loss L between a one-hot encoded Tᵢ (e.g., the ground truth output session tokens) and a generated probability distribution Gᵢ (e.g., the predicted output session tokens) in accordance with the following function:

$${L}_{default} = - {\sum }_{i = 1}^{m} {T}_{i} log {G}_{i} \qquad ( 3 )$$

In one or more instances, the digital page sequence machine learning system 106 utilizes a page order agnostic loss as the measure of loss (e.g., a page order agnostic loss 614 as shown in FIG. 6). In particular, in one or more implementations, the digital page sequence machine learning system 106 utilizes a predicted page of sequence regardless of the sequence in which the pages are predicted to be visited within a session (e.g., to emphasize that a user is predicted to likely visit a set of pages). Indeed, in one or more instances, the digital page sequence machine learning system 106 generates a page order agnostic measure of loss that uses a set matching objective for training the large language model. For example, given a sub-sequence of session tokens that represent a page in a true label (e.g., tokens at sub-word levels), the digital page sequence machine learning system 106 identifies a degree of match with one or more neighboring-sub-sequence of same length, among the sequences of tokens in the predicted page sequence (e.g., predicted output session tokens).

In particular, in one or more instances, the digital page sequence machine learning system 106 computes a page order agnostic loss that matches predicted pages in a page sequence (e.g., output session tokens for predicted pages) regardless of order in the predicted page sequence and the ground truth target page sequence (e.g., the ground truth output session tokens) to obtain a non-zero value of loss. Indeed, in one or more implementations, the digital page sequence machine learning system 106 generates a page order agnostic loss with an objective to reduce or minimize a loss whenever a page from a target session (e.g., the ground truth output session tokens) is present in the predicted page sequence (e.g., the predicted output session tokens) irrespective of its position.

To generate the page order agnostic loss (as shown in FIG. 6), in one or more embodiments, the digital page sequence machine learning system 106 utilizes a matrix to represent the predicted output session token probability distribution Gᵢ and ground truth output session tokens Tᵢ. Indeed, in one or more implementations, the digital page sequence machine learning system 106 utilizes a rolling window, in the matrix, to identify, at each ground truth token(s) from the ground truth output session tokens Tᵢ, negative log-likelihood (NLL) score (e.g., a sum of diagonal NLL values) between the ground truth token(s) from the ground truth output session tokens Tᵢ and the predicted output session tokens in the predicted output session token probability distribution Gᵢ. Furthermore, in one or more instances, the digital page sequence machine learning system 106 selects, for each page in the page sequence, a minimum sum of diagonal NLL along the rolling windows to find closely matching predicted output session tokens from the predicted output session token probability distribution Gᵢ to the ground truth output session tokens Tᵢ (as the page order agnostic loss 614).

For instance, the digital page sequence machine learning system 106 utilizes a matrix (of size m×m) with row indices i representing [symbol] (e.g., the ground truth output session tokens) and column indices j representing [symbol] (e.g., the predicted sequence of session tokens). Furthermore, in one or more cases, the digital page sequence machine learning system 106 utilizes the value at position i,j as the negative log-likelihood (NLL) between the one-hot encoded Tᵢ (e.g., the ground truth output session tokens) and a generated probability distribution G; (e.g., the predicted output session tokens) (e.g., NLL (Tᵢ, Gⱼ). Moreover, for each page P_{n,r}:T[₍ₜ_{_{n,r-1}}₎₊₁, . . . , T₍ₜ_{_{n,r-1}}₎₊₍ₜ_{_{n,r}}₎] (in the page sequence), the digital page sequence machine learning system 106, in one or more instances, utilizes a rolling window matrix of size t_{n,r}×t_{n,r}.

Moreover, in one or more cases, the digital page sequence machine learning system 106, by fixing the rows indexed by tokens in P_{n,r}, shifts the rolling window by one position along the columns Gⱼ. Furthermore, in one or more embodiments, the digital page sequence machine learning system 106 generates a sum of values on the rolling window diagonal. In addition, in one or more instances, the digital page sequence machine learning system 106 increments the index j from 1 to m−t_{n,r}+1. Indeed, in one or more cases, the digital page sequence machine learning system 106 generates a sum of diagonal j, for a given page P_{n,r}, as the sum of NLL values computed between the corresponding tokens in [T₍ₜ_{_{n,r-1}}₎₊₁, . . . , T₍ₜ_{_{n,r-1}}₎₊₍ₜ_{_{n,r}}₎] and [Gⱼ, . . . , Gⱼ₊ₜ_{_{n,r}}₋₁].

Furthermore, in one or more implementations, the digital page sequence machine learning system 106 selects, for each page P_{n,r}, a minimum sum of diagonal among the rolling windows. For example, the digital page sequence machine learning system 106 selects a minimum sum of diagonal such that if the j^{th} rolling window has the minimum sum-of-diagonal, it most closely matches the [G_{j:j+t}_{_{n,r}}₋₁] sub-sequence with the target page sub-sequence (e.g., the ground truth page sub-sequence from the ground truth output session tokens). In one or more implementations, the digital page sequence machine learning system 106 computes the mean of minimum sum of diagonals (as the page order agnostic loss) by repeating the above-mentioned computation for each page in a sample (e.g., in the ground truth output session tokens). For example, the digital page sequence machine learning system 106 generates a page order agnostic loss Lₚₒₐ in accordance with the following function:

$${L}_{p o a} = \frac{1}{N} {{\sum }_{n = 1}}^{N} \frac{1}{{p}_{n}} {\sum }_{r = 1}^{{p}_{n}} {min}_{j ∈ [ 1 , m - ( {t}_{n , r} ) + 1 ]} ( {\sum }_{k = 1}^{k = {t}_{n , r}} NLL ( {T}_{{t}_{n , r - 1} + k} , {G}_{j + ( k - 1 )} ) ) \qquad ( 4 )$$

In the above mentioned function, the digital page sequence machine learning system 106, in one or more implementations, utilizes a number of users (samples) as N (in the training batch) and pₙ as the number of pages for the n^{th} user (sample).

As mentioned above, the digital page sequence machine learning system 106 further utilizes the page order agnostic loss to generate a contrastive measure of loss. In particular, in one or more instances, the digital page sequence machine learning system 106 determines both a minimum measure of loss (e.g., mean of minimum sum of diagonals as described above) and a maximum measure of loss (e.g., mean of maximum sum of diagonals). Moreover, in one or more implementations, the digital page sequence machine learning system 106 generates a contrastive measure of loss utilizing a combination of the minimum measure of loss and maximum measure of loss.

For instance, the digital page sequence machine learning system 106 generates a minimum measure of loss (e.g., mean of minimum sum of diagonals) in accordance with the following function:

$${L}_{page \_ min} = \frac{1}{N} {{\sum }_{n = 1}}^{N} \frac{1}{{p}_{n}} {\sum }_{r = 1}^{{p}_{n}} {min}_{j ∈ [ 1 , m - ( {t}_{n , r} ) + 1 ]} ( {\sum }_{k = 1}^{k = {t}_{n , r}} NLL ( {T}_{{t}_{n , r - 1} + k} , {G}_{j + ( k - 1 )} ) ) \qquad ( 5 )$$

Furthermore, the digital page sequence machine learning system 106 generates a maximum measure of loss (e.g., mean of maximum sum of diagonals) in accordance with the following function:

$${L}_{page \_ max} = \frac{1}{N} {{\sum }_{n = 1}}^{N} \frac{1}{{p}_{n}} {\sum }_{r = 1}^{{p}_{n}} {max}_{j ∈ [ 1 , m - ( {t}_{n , r} ) + 1 ]} ( {\sum }_{k = 1}^{k = {t}_{n , r}} NLL ( {T}_{{t}_{n , r - 1} + k} , {G}_{j + ( k - 1 )} ) ) \qquad ( 6 )$$

Moreover, in one or more instances, the digital page sequence machine learning system 106 utilizes the minimum measure of loss and maximum measure of loss (as described above) to generate the contrastive measure of loss in accordance with the following function:

$${L}_{contrastive \_ custom} = \frac{{L}_{page \_ min}}{{L}_{page \_ max} + {L}_{page \_ min}} \qquad ( 7 )$$

Although one or more embodiments herein describe a particular measure of loss for the large language model, the digital page sequence machine learning system 106, in some instances, utilizes various (or various combinations of) measures of losses, such as, but not limited to, a cross-entropy measure of loss and/or mean-squared error loss. Furthermore, in one or more cases, the digital page sequence machine learning system 106 utilizes a combination of one or more measures of loss (e.g., one or more losses described herein). For example, in some implementations, the digital page sequence machine learning system 106 utilizes a combination of a contrastive, page order agnostic loss and a cross-entropy loss as the measure of loss for the large language model.

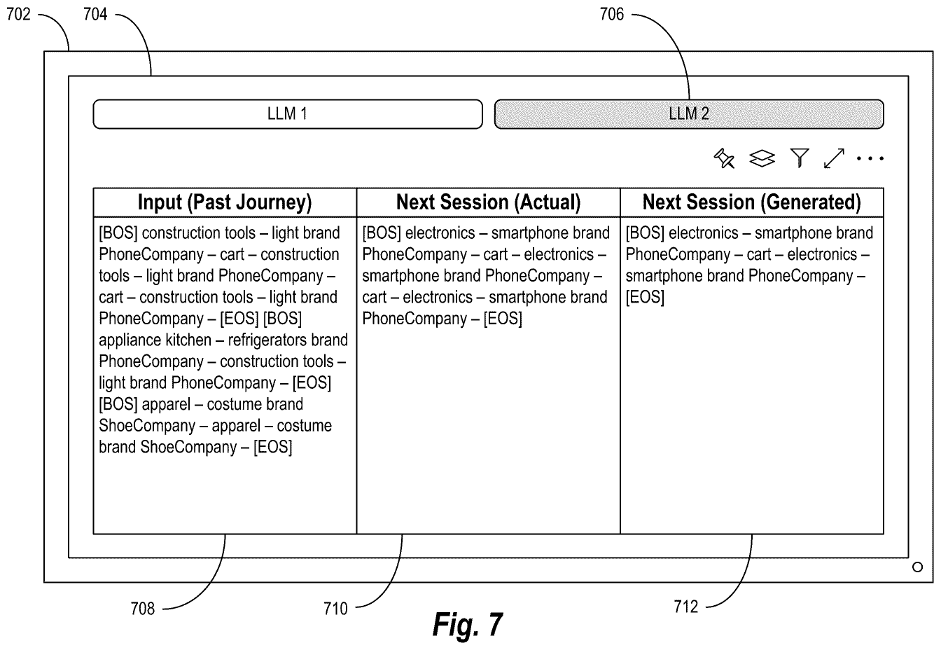

Moreover, FIG. 7 illustrates an example output predicted page sequence generated by a large language model in accordance with one or more implementations herein. For instance, as shown in FIG. 7, the digital page sequence machine learning system 106 provides, for display within a graphical user interface 704 of a client device 702, input user navigation session tokens 708 and predicted page sequence tokens 712 for a future user navigation session generated by a large language model selected in the selectable tab 706 (from the input user navigation session tokens 708) in accordance with one or more implementations herein. In addition, as shown in FIG. 7, the digital page sequence machine learning system 106 provides, for display within the graphical user interface 704 of the client device 702, ground truth user navigation session tokens 710 corresponding to the input user navigation session tokens 708 (e.g., for comparison on an administrator device). In one or more instances, the digital page sequence machine learning system 106 displays the input user navigation session tokens 708 and predicted page sequence tokens 712 on a client device of a user (e.g., without ground truth data).

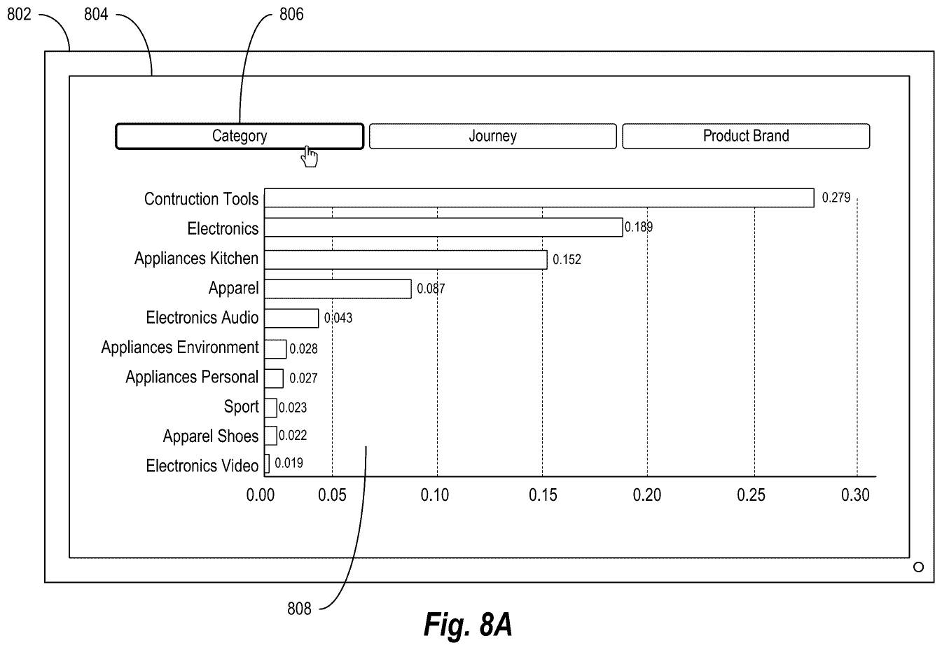

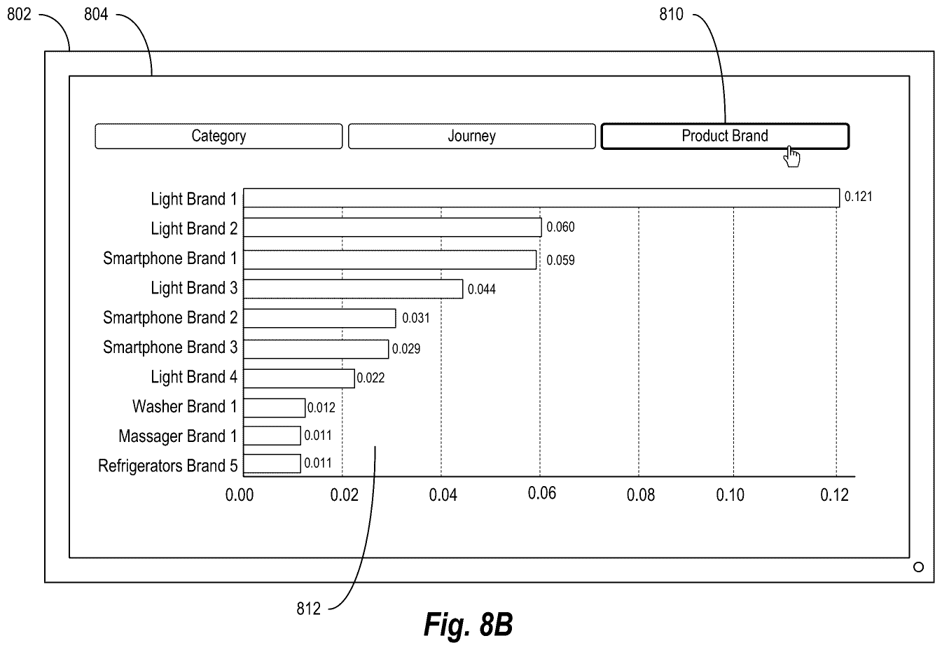

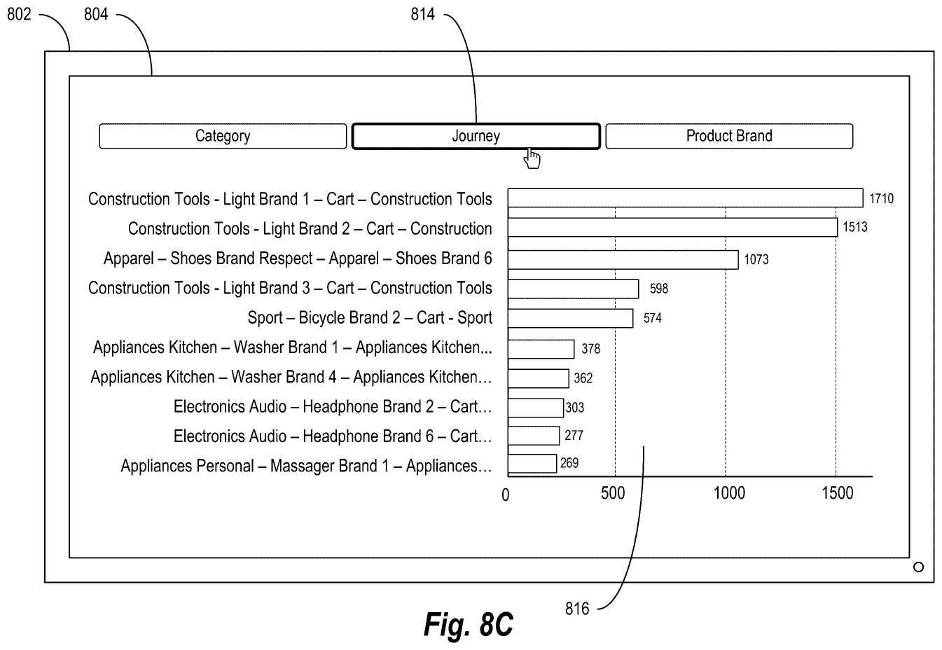

In addition, FIGS. 8A-8C illustrate example generated user activity predictions (e.g., target predictions) from page sequence data in accordance with one or more implementations herein. For example, as shown in FIG. 8A, the digital page sequence machine learning system 106 provides, for display within a graphical user interface 804 of a client device 802, user activity prediction data for category level page visit likelihoods 808 (e.g., predicted likelihood of visits to a particular category by one or more users) upon selection of a category tab 806 (e.g., using category level predicted page sequences in accordance with one or more implementations herein). Furthermore, as shown in FIG. 8B, the digital page sequence machine learning system 106 provides, for display within the graphical user interface 804 of the client device 802, user activity prediction data for product-brand level page visit likelihoods 812 (e.g., predicted likelihood of visits to a particular product-brand page by one or more users) upon selection of a product brand tab 810 (e.g., using product level predicted page sequences in accordance with one or more implementations herein). Additionally, as shown in FIG. 8C, the digital page sequence machine learning system 106 provides, for display within the graphical user interface 804 of the client device 802, user activity prediction data for navigation journey level page visit likelihoods 816 (e.g., predicted likelihood of a particular navigation journey being utilized by one or more users) upon selection of a journey tab 814 (e.g., using product level predicted page sequences in accordance with one or more implementations herein).

Moreover, FIG. 9 illustrates the digital page sequence machine learning system 106 utilizing the predicted page sequence (having category and/or product page information) to generate user segments. As shown in FIG. 9, the digital page sequence machine learning system 106 identifies a plurality of page sequences from users 904 (generated in accordance with one or more implementations herein). Furthermore, as shown in FIG. 9, the digital page sequence machine learning system 106 utilizes similarity measures 914 between a predicted page sequence 902 (of a user) and the plurality of page sequences 904 (from an embedding space 915) to generate user segment(s) 920 (as displayed in a graphical user interface 918 of a client device 916). In one or more instances, the digital page sequence machine learning system 106 determines the user segments utilizing similarity measures and embeddings of predicted page sequences as described in application Ser. No. 18/829,774.

As shown in FIG. 9, the digital page sequence machine learning system 106 provides, for display within the graphical user interface 918 of the client device 916, one or more user segment(s) 920. Indeed, as shown in FIG. 9, the digital page sequence machine learning system 106 displays the identified user segments by group size (e.g., number of users). In addition, as shown in FIG. 9, the digital page sequence machine learning system 106 displays the identified user segments 920 at a category and/or product-brand level granularity from the predicted page sequence data (in accordance with one or more implementations herein).

In one or more instances, the digital page sequence machine learning system 106 selects (or generates) digital content for a user based on the user segments. For instance, the digital page sequence machine learning system 106 utilizes the user segment to select or transmit electronic communications and/or selectable user interface elements to client devices of the users in the user segments (in accordance with one or more implementations herein). Furthermore, in one or more implementations, the digital page sequence machine learning system 106 generates or displays digital reports utilizing the user segments statistics and/or generates target outcomes for the user segments in accordance with one or more implementations herein. For example, the digital page sequence machine learning system 106 utilizes segments of users to identify users that are likely to visit a particular page (e.g., a product page) or perform a target outcome (e.g., an add-to-cart action). Additionally, in one or more cases, the digital page sequence machine learning system 106 utilizes the user segments to select or generate content recommendations (e.g., websites, e-commerce products, video streams, subscriptions, social media) based on the user segments (e.g., using similarities in the navigation session behaviors).

Furthermore, experimenters utilized an implementation of the digital page sequence machine learning system to generate predicted page sequences, target outcome predictions, and target recommendations for users in comparison to baselines. For instance, the experimenters utilized test data for evaluation (that does not appear in training data for an implementation of a digital page sequence machine learning system). Indeed, the experimenters evaluated outputs against the test data session's targets using various metrics. For example, for page sequence prediction, the experimenters utilized intersection/actual as a ratio of number of correctly generated pages to the total number of actual pages (higher being better), intersection/generated as a ratio of number of correctly generated pages to the total number of generated pages (higher being better), false positive proportions (lower being better), and false negative proportions (lower is better). In addition, for outcome prediction, the experimenters compared predicted pages to actual sessions pages to identify correctly determined outcome predictions (e.g. cart or purchase pages) using various metrics, such as accuracy (higher being better), recall (higher being better), precision (higher being better), and F-1 score (higher being better).

For example, experimenters compared evaluation metrics between a baseline GPT4o model to a GPT4o model fine-tuned using prompt few shot learning (in accordance with one or more implementations herein) for page sequence prediction. For instance, as shown in Table 1 below, the GPT4o model fine-tuned using prompt few shot learning (in accordance with one or more implementations herein) outperformed a baseline GPT4o in page sequence prediction.

TABLE 1

| | | All Pages: | All Pages: | All Pages: | All Pages: |
|---|---|---|---|---|---|
| | Fine- | Intersection/ | Intersection/ | False | False |
| Model | Tune/Prompt | Actual | Generated | Positive | Negative |
| GPT-4o | Prompt-zeroshot | 0.198 | 0.136 | 0.864 | 0.802 |
| GPT-4o | Prompt-fewshot | 0.268 | 0.229 | 0.771 | 0.732 |

Moreover, experimenters compared evaluation metrics between a baseline T₅ encoder-decoder model and a custom T₅ encoder-decoder model trained utilizing a contrastive loss (in accordance with one or more implementations herein). Indeed, as shown in Table 2 (e.g., page prediction evaluation) and Table 3 (e.g., target outcome prediction evaluation) below, the custom T₅ encoder-decoder model trained utilizing a contrastive loss (in accordance with one or more implementations herein) performed better or on par with the baseline T₅ encoder-decoder model and outperformed the baseline GPT-4o model (from Table 1).

TABLE 2

| | | All Pages: | All Pages: | All Pages: | All Pages: |
|---|---|---|---|---|---|
| | Fine- | Intersection/ | Intersection/ | False | False |
| Model | Tune/Prompt | Actual | Generated | Positive | Negative |
| T5-Base | Fine-Tune | 0.259 | 0.337 | 0.663 | 0.741 |
| T5-Custom | Fine-Tune | 0.262 | .331 | 0.669 | 0.738 |

TABLE 3

| | | Cart or | Cart or | Cart or | Cart or |
|---|---|---|---|---|---|
| | Fine- | Purchase | Purchase | Purchase | Purchase F1- |
| Model | Tune/Prompt | Accuracy | Recall | Precision | Score |
| GPT-4o | Prompt-zeroshot | 0.955 | 0.588 | 0.487 | 0.533 |
| GPT-4o | Prompt-fewshot | 0.933 | 0.611 | 0.504 | 0.552 |

Additionally, experimenters compared evaluation metrics for outcome predictions between a bi-LSTM (e.g., a specialized outcome prediction model) and a T₅ encoder-decoder model trained in accordance with one or more implementations herein (e.g., T₅-Base-Custom). For instance, Table 4 illustrates the evaluation metric comparisons between the bi-LSTM and the T₅ encoder-decoder model trained in accordance with one or more implementations herein. As shown in Table 4, the T₅-Base-Custom (in accordance with one or more implementations herein) performed better or on par with the baseline T₅ encoder-decoder model and the Bi-LSTM model.

TABLE 4

| | | Cart or | Cart or | Cart or | Cart or |
|---|---|---|---|---|---|
| | Fine- | Purchase | Purchase | Purchase | Purchase F1- |
| Model | Tune/Prompt | Accurac | Recall | Precision | Score |
| T5-Base | Fine-Tune | 0.955 | 0.588 | 0.487 | 0.533 |
| T5-Base- | Prompt- | 0.933 | 0.611 | 0.504 | 0.552 |
| Custom | fewshot | | | | |
| Bi-LSTM | | 0.960 | 0.402 | 0.627 | 0.490 |

Moreover, the experimenters utilized a recommender system model specialized in product-brand recommendations (e.g., trained on product-brand pages across a training dataset) lightGBM (e.g., RecSYS:lightGBM) as a baseline for product-brand page predictions. Indeed, the experimenters compared evaluation metrics between the baseline model to several large language models (e.g., GPT4o, GPT2, and T5 encoder-decoder model) fine-tuned in accordance with one or more implementations herein. As shown in Table 5, the large language models fine-tuned in accordance with one or more implementations herein outperform the lightGBM model in product-brand recommendation prediction tasks.

TABLE 5

| | Fine- | | Product-Brand | Product-Brand |
|---|---|---|---|---|
| Model | Tune/Prompt | Input | Intersection/Actual | Intersection/Generated |
| GPT4o: Zero-Shot | Fine-Tune | Product-Brand | 0.171 | 0.153 |
| GPT4o: Few-Shot | Fine-Tune | Category and | 0.212 | 0.188 |
| | | Product-Brand | | |
| GPT2 | Fine-Tune | Product-Brand | 0.169 | 0.102 |
| T5-Base-Default | Fine-Tune | Category and | 0.213 | 0.280 |
| | | Product-Brand | | |
| RecSYS: lightGBM | | Product-Brand | 0.056 | 0.024 |

Turning now to FIG. 10, additional detail will be provided regarding components and capabilities of one or more embodiments of the digital page sequence machine learning system. In particular, FIG. 10 illustrates an example digital page sequence machine learning system 106 executed by a computing device 1000 (e.g., the server device(s) 102, the client devices 110a-110n, and/or the administrator device 118). As shown by the embodiment of FIG. 10, the computing device 1000 includes or hosts the data analytics system 104 and the digital page sequence machine learning system 106. Furthermore, as shown in FIG. 10, the data analytics system 104 includes a navigation data tokenizer 1002, an input prompt generator 1004, a large language model manager 1006, a digital user activity prediction model manager 1008, a digital content manager 1010, and data storage manager 1012.

As just mentioned, and as illustrated in the embodiment of FIG. 10, the digital page sequence machine learning system 106 includes navigation data tokenizer 1002. For example, the navigation data tokenizer 1002 generates page descriptors from user navigation page sequence data (e.g., page URL visits) as described above (e.g., in relation to FIG. 3). Furthermore, in one or more cases, the navigation data tokenizer 1002 generates user navigation session tokens from the page descriptors (e.g., arrival of source tokens, page tokens, beginning of session tokens, intersession time tokens, end of session tokens) as described above (e.g., in relation to FIG. 3). Moreover, in one or more instances, the navigation data tokenizer 1002 also generates user navigation session token training data as described above (e.g., in relation to FIG. 3).

Additionally, as shown in FIG. 10, the digital page sequence machine learning system 106 includes input prompt generator 1004. In some cases, the input prompt generator 1004 generates an input prompt utilizing a request to generate a predicted page sequence and sample user navigation session tokens of a user (e.g., a zero-shot prompt) as described above (e.g., in relation to FIG. 4). Moreover, the input prompt generator 1004 also generates an input prompt utilizing a request to generate a predicted page sequence, sample user navigation session tokens of a user, and sample training user navigation session tokens of additional users (e.g., a few-shot prompt) as described above (e.g., in relation to FIG. 4).

Furthermore, as shown in FIG. 10, the digital page sequence machine learning system 106 includes the large language model manager 1006. In some embodiments, the large language model manager 1006 utilizes an input prompt to generate a predicted page sequence for one or more users as described above (e.g., in relation to FIGS. 4 and 6). Additionally, in some cases, the large language model manager 1006 also trains a large language model utilizing a contrastive, page order agnostic loss as described above (e.g., in relation to FIG. 6).

Additionally, as shown in FIG. 10, the digital page sequence machine learning system 106 includes the digital user activity prediction model manager 1008. In some embodiments, the digital user activity prediction model manager 1008 utilizes predicted page sequence data of users to generate one or more predicted user activities for the users as described above (e.g., in relation to FIG. 4). Indeed, in some cases, the digital user activity prediction model manager 1008 utilizes predicted page sequence data of users with a user activity prediction model to generate the one or more predicted user activities as described above (e.g., in relation to FIG. 4).

Moreover, as shown in FIG. 10, the digital page sequence machine learning system 106 includes the digital content manager 1010. In some cases, the digital content manager 1010 utilizes a predicted user activity data and/or predicted page sequence data to select digital content for a client device of a user corresponding to the user navigation data as described above (e.g., in relation to FIG. 5). Furthermore, the digital content manager 1010 also generates or identifies user segments utilizing a predicted page sequence and/or predicted user activity data as described above (e.g., in relation to FIG. 9).

As further shown in FIG. 10, the digital page sequence machine learning system 106 includes the data storage manager 1012. In some embodiments, the data storage manager 1012 maintains data to perform one or more functions of the digital page sequence machine learning system 106. For example, the data storage manager 1012 includes large language models, large language model parameters, training user navigation data, user navigation session tokens and/or navigation session data, predicted page sequences, user activity prediction models and data, user activity prediction data, digital content, and/or user segmentation data.

Each of the components 1002-1012 of the computing device 1000 (e.g., the computing device 1000 implementing the digital page sequence machine learning system 106), as shown in FIG. 10, may be in communication with one another using any suitable technology. The components 1002-1012 of the computing device 1000 can comprise software, hardware, or both. For example, the components 1002-1012 can comprise one or more instructions stored on a computer-readable storage medium and executable by processor of one or more computing devices. When executed by the one or more processors, the computer-executable instructions of the digital page sequence machine learning system 106 (e.g., via the computing device 1000) can cause a client device and/or server device to perform the methods described herein. Alternatively, the components 1002-1012 and their corresponding elements can comprise hardware, such as a special purpose processing device to perform a certain function or group of functions. Additionally, the components 1002-1012 can comprise a combination of computer-executable instructions and hardware.

Furthermore, the components 1002-1012 of the digital page sequence machine learning system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1012 may be implemented as a stand-alone application, such as a desktop or mobile application. Furthermore, the components 1002-1012 may be implemented as one or more web-based applications hosted on a remote server. The components 1002-1012 may also be implemented in a suite of mobile device applications or “apps.” To illustrate, the components 1002-1010 may be implemented in an application, including but not limited to, ADOBE ANALYTICS CLOUD, ADOBE ANALYTICS, ADOBE AUDIENCE MANAGER, ADOBE CAMPAIGN, ADOBE EXPERIENCE MANAGER, and ADOBE TARGET. “ADOBE,” “ADOBE ANALYTICS CLOUD,” “ADOBE ANALYTICS,” “ADOBE AUDIENCE MANAGER,” “ADOBE CAMPAIGN,” “ADOBE EXPERIENCE MANAGER,” and “ADOBE TARGET” are either registered trademarks or trademarks of Adobe Inc. in the United States and/or other countries.

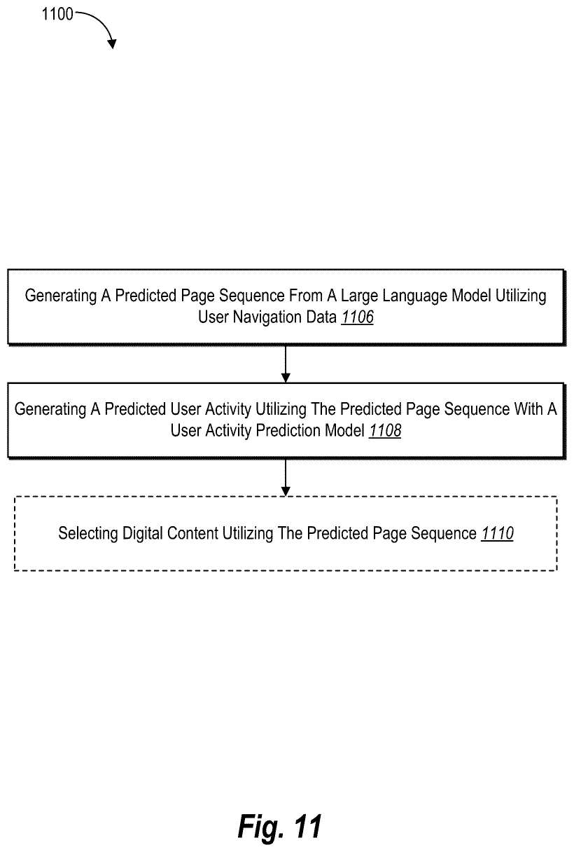

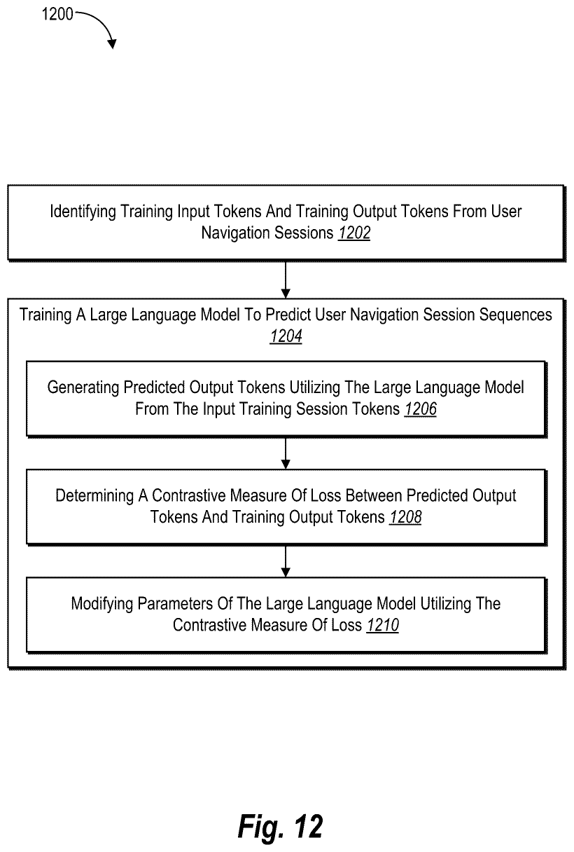

FIGS. 1-10, the corresponding text, and the examples provide a number of different methods, systems, devices, and non-transitory computer-readable media of the digital page sequence machine learning system 106. In addition to the foregoing, one or more embodiments can also be described in terms of flowcharts comprising acts for accomplishing a particular result, as shown in FIGS. 11 and 12. The acts shown in FIGS. 11 and 12 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIGS. 11 and 12. In some embodiments, a system can be configured to perform the acts of FIGS. 11 and 12.

Alternatively, the acts of FIGS. 11 and 12 can be performed as part of a computer implemented method.

As mentioned above, FIG. 11 illustrates a flowchart of a series of acts 1100 for utilizing predicted page sequence data from large language models to generate user activity predictions for users in accordance with one or more implementations. While FIG. 11 illustrates acts according to one embodiment, alternative embodiments may omit, add to, reorder, and/or modify any of the acts shown in FIG. 11. For instance, as shown in FIG. 11, the series of acts 1100 include an act 1106 of generating a predicted page sequence from a large language model utilizing user navigation data, an act 1108 of generating a predicted user activity utilizing the predicted page sequence with a user activity prediction model, and, in some cases, an act 1110 of selecting digital content utilizing the predicted page sequence.

In one or more instances, the series of acts 1100 include generating, utilizing a tokenizer, a set of user navigation session tokens from page sequence descriptors identified from a user navigation session corresponding to a user, generating, utilizing a large language model with the set of user navigation session tokens, a predicted page sequence for an additional user navigation session, utilizing the predicted page sequence with a user activity prediction model to generate a predicted user activity for the user, and selecting digital content for a client device of the user based on the predicted user activity. For example, the predicted user activity for the user includes a target prediction, a page visit time prediction, a user activity frequency prediction, a target conversion outcome prediction, or a segment of users for a target product.

Moreover, in some instances, the series of acts 1100 include identifying a set of user navigation session tokens from page sequence descriptors identified from a user navigation session corresponding to a user, generating, utilizing a large language model with a set of user navigation session tokens from a user navigation session corresponding to a user, a predicted page sequence for an additional user navigation session, generating, utilizing a user activity prediction model with a set of user activity data, a predicted user insight, and determining a predicted user activity based on a combination of the predicted page sequence and the predicted user insight. For instance, the predicted user activity for the user includes a target prediction, a page visit time prediction, a user activity frequency prediction, a target conversion outcome prediction, or a segment of users for a target product.

In some implementations, the series of acts 1100 include generating a first user navigation session token from a category page descriptor and generating a second user navigation session token from a product page descriptor associated with the category page descriptor. In some instances, the series of acts 1100 include generating a target prediction by utilizing the predicted page sequence with the user activity prediction model to generate a predicted category target for the user or a predicted product page target for the user, selecting, as the digital content, an electronic communication based on the predicted category target for the user or the predicted product page target for the user, and transmitting the electronic communication to the client device of the user.

Moreover, in some instances the series of acts 1100 include generating, utilizing the user activity prediction model, a predicted user insight from user activity data and utilizing the predicted page sequence with the predicted user insight from the user activity prediction model to generate the predicted user activity for the user. Moreover, in some cases, the series of acts 1100 include generating the predicted user activity (or the page visit time prediction) by generating, utilizing the user activity prediction model, a predicted time-instance of a subsequent user page visit as the predicted user insight and determining a predicted time-instance for a particular page from a combination of the predicted page sequence and the predicted time-instance of a subsequent user page visit.

In addition, in some cases, the series of acts 1100 include generating the predicted user activity (or a user activity frequency prediction) by generating, utilizing the user activity prediction model, a user consumption metric for the user as the predicted user insight, determining a user activity frequency prediction based on the user consumption metric and the predicted page sequence, and selecting, as the digital content, an electronic communication based on the user activity frequency prediction.

Additionally, in some implementations, the series of acts 1100 include generating the predicted user activity by determining a target conversion outcome prediction for the user. For example, the series of acts 1100 include generating the target conversion outcome prediction by determining an add-to-cart action, a digital media content item view, a conversion action, or an exit website action. Additionally, in some embodiments, the series of acts 1100 include selecting, as the digital content, a product recommendation communication based on a predicted product page from the predicted page sequence and the target conversion outcome prediction for the user.

Moreover, in some instances, the series of acts 1100 include selecting the digital content for the client device of the user by selecting an electronic communication based on the predicted user activity or a selectable option to navigate to a target outcome from the predicted user activity. In some cases, the series of acts 1100 include generating the predicted user activity by determining a target conversion outcome for the user and selecting a product recommendation communication to transmit to a client device of the user based on a predicted product page from the predicted page sequence and the target conversion outcome for the user.

In one or more cases, the series of acts 1100 include utilizing the predicted user activity for the user with an inventory forecasting model to generate a predicted inventory of a website. Moreover, the series of acts 1100 include generating, utilizing the large language model, a plurality of predicted page sequences for a plurality of users and determining a segment of users for a target product based on comparisons between the predicted page sequence for a user corresponding to the user navigation session and the plurality of predicted page sequences for the plurality of users. Moreover, the series of acts 1100 include selecting digital content for a client device of the user by selecting an electronic communication based on the predicted user activity or a selectable option to navigate to a target outcome from the predicted user activity.

As mentioned above, FIG. 12 illustrates a flowchart of a series of acts 1200 for training a large language model to generate predicted page sequence data for users in accordance with one or more implementations. While FIG. 12 illustrates acts according to one embodiment, alternative embodiments may omit, add to, reorder, and/or modify any of the acts shown in FIG. 12. For instance, as shown in FIG. 12, the series of acts 1200 include an act 1202 of identifying training input tokens and training output tokens from user navigation sessions and an act 1204 of training a large language model to predict user navigation session sequences through an act 1206 of generating predicted output tokens utilizing the large language model from the training input session tokens, an act 1208 of determining a contrastive measure of loss between predicted output tokens and training output tokens, and an act 1210 of modifying parameters of the large language model utilizing the contrastive measure of loss.

In some cases, the series of acts 1200 include training a large language model to predict user navigation session sequences from page navigation sequence data by generating predicted output tokens utilizing the large language model from the input training session tokens, determining a contrastive measure of loss based on maximum measures of loss and minimum measures of loss between the predicted output tokens and the training output tokens, and modifying parameters of the large language model based on the contrastive measure of loss.

In some embodiments, the series of acts 1200 includes generating training input tokens and training output tokens utilizing category page descriptors and product page descriptors. Moreover, in some instances, the series of acts 1200 includes training the large language model to predict user navigation session sequences by modifying the parameters of the large language model utilizing a page order agnostic measure of loss. Furthermore, in one or more instances, the series of acts 1200 include determining the maximum measures of loss and minimum measures of loss from a rolling window summation of loss measures between the predicted output tokens and the training output tokens.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., the server device(s) 102, the client devices 110a-110n, and/or the administrator device 118). In one or more implementations, the computing device 1300 may be a mobile device (e.g., a mobile telephone, a smartphone, a PDA, a tablet, a laptop, a camera, a tracker, a watch, a wearable device, etc.). In some implementations, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other implementations. Furthermore, in certain implementations, the computing device 1300 includes fewer components than those shown in FIG. 13. Components of the computing device 1300 shown in FIG. 13 will now be described in additional detail.

In particular implementations, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (“HDD”), flash memory, a Universal Serial Bus (“USB”) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (“NIC”) or network adapter for communicating with an Ethernet or other wire-based network or a wireless NIC (“WNIC”) or wireless adapter for communicating with a wireless network, such as a WI-FI. The computing device 1300 further include a bus 1312. The bus 1312 can include hardware, software, or both that connects components of the computing device 1300 to each other.

In the foregoing specification, the invention has been described with reference to specific example implementations thereof. Various implementations and aspects of the invention(s) are described with reference to details discussed herein, and the accompanying drawings illustrate the various implementations. The description above and drawings are illustrative of the invention and are not to be construed as limiting the invention. Numerous specific details are described to provide a thorough understanding of various implementations of the present invention.

The present invention may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause the at least one processor to perform operations comprising:
generating, utilizing a tokenizer, a set of user navigation session tokens from page sequence descriptors identified from a user navigation session corresponding to a user;
generating, utilizing a large language model with the set of user navigation session tokens, a predicted page sequence for an additional user navigation session;
utilizing the predicted page sequence with a user activity prediction model to generate a predicted user activity for the user, wherein the predicted user activity comprises a page visit time prediction, a target prediction, a user activity frequency prediction, a target conversion outcome prediction, or a segment of users for a target product; and
selecting digital content for a client device of the user based on the predicted user activity.

2. The non-transitory computer-readable medium of claim 1, wherein the operations further comprise generating a first user navigation session token from a category page descriptor and generating a second user navigation session token from a product page descriptor associated with the category page descriptor.

3. The non-transitory computer-readable medium of claim 1, wherein the operations further comprise:
generating the target prediction by utilizing the predicted page sequence with the user activity prediction model to generate a predicted category target for the user or a predicted product page target for the user;
selecting, as the digital content, an electronic communication based on the predicted category target for the user or the predicted product page target for the user; and
transmitting the electronic communication to the client device of the user.

4. The non-transitory computer-readable medium of claim 1, wherein the operations further comprise:
generating, utilizing the user activity prediction model, a predicted user insight from user activity data; and
utilizing the predicted page sequence with the predicted user insight from the user activity prediction model to generate the predicted user activity for the user.

5. The non-transitory computer-readable medium of claim 4, wherein the operations further comprise generating the page visit time prediction by:
generating, utilizing the user activity prediction model, a predicted time-instance of a subsequent user page visit as the predicted user insight; and
determining a predicted time-instance for a particular page from a combination of the predicted page sequence and the predicted time-instance of a subsequent user page visit.

6. The non-transitory computer-readable medium of claim 4, wherein the operations further comprise:
generating the user activity frequency prediction by:
generating, utilizing the user activity prediction model, a user consumption metric for the user as the predicted user insight; and
determining the user activity frequency prediction based on the user consumption metric and the predicted page sequence; and
selecting, as the digital content, an electronic communication based on the user activity frequency prediction.

7. The non-transitory computer-readable medium of claim 1, wherein the operations further comprise generating the target conversion outcome prediction by determining an add-to-cart action, a digital media content item view, a conversion action, or an exit website action.

8. The non-transitory computer-readable medium of claim 7, wherein the operations further comprise selecting, as the digital content, a product recommendation communication based on a predicted product page from the predicted page sequence and the target conversion outcome prediction for the user.

9. The non-transitory computer-readable medium of claim 1, wherein the operations further comprise selecting the digital content for the client device of the user by selecting an electronic communication based on the predicted user activity or a selectable option to navigate to a target outcome from the predicted user activity.

10. A system comprising:
a memory component comprising training input tokens and training output tokens from user navigation sessions; and
a processing device coupled to the memory component, wherein the processing device is configured to perform operations comprising training a large language model to predict user navigation session sequences from page navigation sequence data by:
generating predicted output tokens utilizing the large language model from the training input session tokens;
determining a contrastive measure of loss based on maximum measures of loss and minimum measures of loss between the predicted output tokens and the training output tokens; and
modifying parameters of the large language model based on the contrastive measure of loss.

11. The system of claim 10, wherein the processing device is configured to perform operations comprising generating training input tokens and training output tokens utilizing category page descriptors and product page descriptors.

12. The system of claim 10, wherein the processing device is configured to perform operations comprising training the large language model to predict user navigation session sequences by modifying the parameters of the large language model utilizing a page order agnostic measure of loss.

13. The system of claim 10, wherein the processing device is configured to perform operations comprising determining the maximum measures of loss and minimum measures of loss from a rolling window summation of loss measures between the predicted output tokens and the training output tokens.

14. A computer-implemented method comprising:
identifying a set of user navigation session tokens from page sequence descriptors identified from a user navigation session corresponding to a user;
generating, utilizing a large language model with a set of user navigation session tokens from a user navigation session corresponding to a user, a predicted page sequence for an additional user navigation session;
generating, utilizing a user activity prediction model with a set of user activity data, a predicted user insight; and
determining a predicted user activity based on a combination of the predicted page sequence and the predicted user insight, wherein the predicted user activity comprises a target prediction, a page visit time prediction, a user activity frequency prediction, a target conversion outcome prediction, or a segment of users for a target product.

15. The computer-implemented method of claim 14, further comprising generating the page visit time prediction by:
generating, utilizing the user activity prediction model, a predicted time-instance of a subsequent user page visit as the predicted user insight; and
determining a predicted time-instance for a particular page from a combination of the predicted page sequence and the predicted time-instance of a subsequent user page visit.

16. The computer-implemented method of claim 14, further comprising:
generating the user activity frequency prediction by:
generating, utilizing the user activity prediction model, a user consumption metric for the user as the predicted user insight; and
determining the user activity frequency prediction based on the user consumption metric and the predicted page sequence; and
selecting, as digital content, an electronic communication based on the user activity frequency prediction.

17. The computer-implemented method of claim 14, further comprising:
generating the target conversion outcome prediction by determining an add-to-cart action, a digital media content item view, a conversion action, or an exit website action; and
selecting a product recommendation communication to transmit to a client device of the user based on a predicted product page from the predicted page sequence and the target conversion outcome prediction for the user.

18. The computer-implemented method of claim 14, further comprising utilizing the predicted user activity for the user with an inventory forecasting model to generate a predicted inventory of a website.

19. The computer-implemented method of claim 14, further comprising:
generating, utilizing the large language model, a plurality of predicted page sequences for a plurality of users; and
determining the segment of users for the target product based on comparisons between the predicted page sequence for a user corresponding to the user navigation session and the plurality of predicted page sequences for the plurality of users.

20. The computer-implemented method of claim 14, further comprising selecting digital content for a client device of the user by selecting an electronic communication based on the predicted user activity or a selectable option to navigate to a target outcome from the predicted user activity.
